(19) United States
(12) Patent Application Publication
(10) Pub. No.: US 2019/0070566 A1
(43) Pub. Date: Mar. 7, 2019

(54) TECHNIQUES FOR PERFORMING DIFFUSION-BASED FILTRATION USING NANOPOROUS MEMBRANES AND RELATED SYSTEMS AND METHODS

(71) Applicant: Massachusetts Institute of Technology, Cambridge, MA (US)

(72) Inventors: Piran Kidambi, Somervile, MA (US); Rohit N. Karmik, Cambridge, MA (US); Doojoon Jang, Cambridge, MA (US); Michael S.H. Boutilier, Fremont, CA (US); Sui Zhang, Cambridge, MA (US)

(73) Assignee: Massachusetts Institute of Technology, Cambridge, MA (US)

(21) Appl. No.: 16/081,164

(22) PCT Filed: Nov. 3, 2017
(86) PCT No.: PCT/US2017/059981

§ 371 Date: Aug. 30, 2018

Related U.S. Application Data
(60) Provisional application No. 62/418,064, filed on Nov. 4, 2016.

(51) Int. Cl. B01D 69/12; B01D 71/02; B01D 61/24; B01D 67/00

(52) U.S. Cl. CPC B01D 69/125; B01D 71/02; B01D 61/243; B82Y 30/00; B01D 67/0088; B01D 2323/286; B01D 67/0062

(57) ABSTRACT

According to some aspects, a semi-permeable membrane is provided for performing separation processes as well as its method of manufacture. In some instances, a membrane may include a porous substrate, and an active layer disposed upon the substrate. The active layer may include at least one atomically thin layer having a plurality of open pores that allow transport of some species through the membrane while restricting transport of other species through the membrane. The open pores may have a mean pore size between 0.5 nm and 10 nm and a number density between 10⁹ cm⁻² and 1014 cm⁻².

### CROSS-REFERENCE TO RELATED APPLICATIONS

This application is a national stage filing under 35 U.S.C. 371 of International Patent Application Serial No. PCT/US2017/059981, filed Nov. 3, 2017, which claims the benefit under 35 U.S.C. § 119(e) of U.S. provisional application Ser. No. 62/418,064, filed Nov. 4, 2016, each of which is incorporated by reference in its entirety.

### FEDERALLY SPONSORED RESEARCH

This invention was made with Government support under Grant No. DE-SC0008059 awarded by the Department of Energy. The Government has certain rights in the invention.

### BACKGROUND

Many industries and applications, such as water purification, chemical synthesis, pharmaceutical purification, refining, natural gas separation, and others utilize membrane-based separation processes. The need for membranes with high selectivity and flux for both liquid-phase and gas-phase membranes has led to many improvements in ceramic and polymer-based membranes over the past few decades. One of the primary challenges has been to maximize flux while maintaining high selectivity. Typically, increasing flux rate necessitates a decrease in selectivity. Another challenge is maintaining good chemical resistance. While several decades of research has resulted in development of polymeric or ceramic membranes, further advances in membrane technology will likely rely on new membrane materials that provide better transport properties. Recent advances in two-dimensional (2D) materials such as graphene have opened new opportunities to advance membrane technology, where these 2D materials can form the active layer that confers selectivity.

### SUMMARY

According to one aspect, a semi-permeable membrane is provided for performing separation processes, the membrane comprising a porous substrate, and an active layer disposed upon the substrate, wherein the active layer includes at least one atomically thin layer, the active layer having a plurality of open pores that allow transport of some species through the membrane while restricting transport of other species through the membrane, wherein the open pores have a mean pore size between 0.3 nm and 10 nm, and wherein the open pores have a number density between 10⁹ cm⁻² and 10¹⁴ cm⁻².

According to another aspect, a method of performing dialysis is provided, the method comprising separating a first group of species from a second group of species using a semi-permeable membrane, the semi-permeable membrane comprising a porous substrate, and an active layer disposed upon the substrate, wherein the active layer includes at least one atomically thin layer, the active layer having a plurality of open pores that allow transport of species of the first group through the membrane while restricting transport of species of the second group through the membrane, wherein the open pores have a mean pore size between 0.5 nm and 10 nm, and wherein the open pores have a number density between 10⁹ cm⁻² and 10¹⁴ cm⁻² wherein the first species pass through the semi-permeable membrane primarily through diffusion.

According to yet another aspect, a method of forming a semi-permeable membrane includes: disposing an atomically thin layer of a first material onto a surface of a porous substrate; forming a plurality of open pores in the layer of the first material, the open pores allowing transport of some molecules through the membrane whilst restricting transport of other molecules through the membrane, wherein the open pores have a mean pore size between 0.5 nm and 10 nm, and wherein the open pores have a number density between 10⁹ cm⁻² and 10¹⁴ cm⁻².

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 is a schematic of a nanoporous atomically thin layer disposed upon a porous substrate, according to some embodiments;

FIG. 2 is a schematic of a nanoporous atomically thin layer disposed upon a porous substrate with defects and tears present in the atomically thin layer, according to some embodiments;

FIGS. 3A-3B are high resolution scanning tunneling electron microscopy (STEM) images showing nanoscale pores in a hexagonal graphene lattice, according to some embodiments;

FIG. 4 illustrates a process of forming a nanoporous atomically thin layer disposed upon a porous substrate, with inset FIG. 4A showing a view of the surface of the membrane at a small scale, according to some embodiments;

FIG. 5 is a flowchart of a method of producing a nanoporous atomically thin layer, according to some embodiments;

FIG. 6 depicts an illustrative process of stacking multiple atomically thin layers of graphene upon a polycarbonate track etched membrane (PCTEM), according to some embodiments;

FIG. 7 depicts an illustrative process of forming a nanoporous atomically thin graphene layer by etching with oxygen plasma, according to some embodiments;

FIG. 8 illustrates surface features of a nanoporous atomically thin layer at various length scales, according to some embodiments;

FIG. 9 illustrates filling of defects in an atomically thin layer of graphene, according to some embodiments;

FIG. 10A illustrates a first illustrative technique for filling of defects in an atomically thin layer, according to some embodiments;

FIG. 10B illustrates a second illustrative technique for filling of defects in an atomically thin layer, according to some embodiments;

FIG. 11 is a schematic cross-sectional view of an active layer including multiple stacked atomically thin layers, according to some embodiments;

FIG. 12 is a schematic perspective cross-sectional view of sealing a defect in an active layer disposed on a substrate, according to some embodiments;

FIG. 13 is a schematic cross-sectional view of a membrane including an active layer disposed on a substrate, according to some embodiments;

FIG. 14 is a schematic cross-sectional view of the membrane of FIG. 13 after sealing the defects using an interfacial reaction, according to some embodiments;

FIGS. 15A-15B illustrate a dialysis process, or other diffusion based filtration process, that may be implemented using a nanoporous atomically thin layer, according to some embodiments;

FIG. 16 depicts experimental data showing histograms of pore sizes and number density as a function of the duration of an oxygen plasma application, according to some embodiments;

FIGS. 17A-17B depict experimental data illustrating the selectivity of a nanoporous atomically thin layer against four different molecule types based on different oxygen plasma application techniques and durations, according to some embodiments;

FIG. 18 illustrates experimental data of molecular concentrations in a process of separating a salt from a larger molecule using a commercial polymeric membrane;

FIGS. 19A-19C depict experimental data of molecular concentrations in a process of separating a salt from a larger molecule using a nanoporous atomically thin membrane, according to some embodiments;

FIG. 20A is a schematic flow diagram of one embodiment of a method to form a porous PES substrate on an atomically thin active layer;

FIGS. 20B and 20C are scanning electron micrographs of a porous PES substrate formed on an atomically thin active layer;

FIG. 21A is a graph of measured permeance for different membranes;

FIG. 21B is a graph of measured selectivity for different membranes;

FIG. 21C is a graph of measured selectivity vs. permeance for a membrane including graphene and a PES substrate as compared to different commercial membranes; and

FIG. 22 is a graph of normalized concentration of different solutes during a diffusion cell experiment for different membranes.

### DETAILED DESCRIPTION

Various filtration processes are often used in biochemical processing, biological research and/or medical applications, and are typically based on relatively thick (>100 nm) porous polymer membranes. These polymer membranes, however, suffer from low rates of diffusion (often several hours) leading to long process times, and have poor selectivity of molecules of interest. The inventors have developed techniques to produce nanoporous atomically thin layers (NATMs) that enable fast size-selective biochemical separation, offering (in at least some cases) greater than an order of magnitude reduction in process time over conventional polymer membranes while also providing a greater selectivity relative to molecules, ions or other filtrates of interest.

In a typical filtration process such as dialysis, a sample and a buffer solution are separated by a semi-permeable membrane. A difference in sample concentration across the membrane leads to diffusion of sample molecules through the membrane. However, certain molecules may be unable to effectively diffuse through the membrane due to their size and shape and the dimensions and geometries of pores of the membrane. In dialysis, for instance, smaller species such as salts, ions, small molecules, small proteins, solvents, reducing agents and/or dyes are often separated from larger species such as larger macromolecules such as proteins, DNA, polysaccharides, buffer exchange, and/or purifying peptides. Accordingly, it is desirable that a semi-permeable membrane used in such an application be one that allows fast diffusion through its structure of at least one molecule of interest while also effectively separating out other molecules (i.e., has high selectivity).

One useful quantity to characterize diffusive transport across a membrane is the effective membrane thickness given by:

$$J = D \times \frac{Δ c}{L}$$

where J is the diffusive flux (kg m⁻² s⁻¹), D is diffusivity of the molecule in free solution, Δc is the concentration difference across the membrane, and L is the effective membrane thickness. For an ideal membrane, the effective membrane thickness would be equal to the actual thickness of the membrane. However, in general this will not be the case since pores of a membrane cover only a fraction of the membrane area. As such, the effective membrane thickness is usually larger than the actual thickness of the membrane. Commercially available dialysis membranes often have an effective membrane thickness of approximately 1 mm, which has a direct implication as to the process timescale. In particular, diffusion of a substantial fraction of a particular type of molecule through a membrane having such an effective length may take a matter of hours or even days for conventional membranes. Further, this problem cannot be addressed by conventional membranes, such as polymeric membranes, since they are not amenable to being fabricated in thinner sizes.

Two-dimensional atomically-thin materials including a single, or in some instances several, atomic layers, have immense potential for use as highly-permeable, highly-selective active layers of filtration membranes. Due to the ability to create angstrom and nanometer scale pores in a single sheet of these materials, two dimensional materials have the ability to effectively and efficiently permit selective transport of molecules for filtration in liquid and gas separation processes. Additionally, and without wishing to be bound by theory, the ultrathin thicknesses associated with these materials may permit extremely high permeance and corresponding flow rates while maintaining better selectivity as compared to less-organized polymeric membranes.

The inventors have recognized and appreciated techniques to produce atomically thin layers that are particularly effective for filtration processes such as dialysis, nanofiltration, diafiltration, forward osmosis, or combinations thereof. These membranes have an effective thickness at least several times smaller than that of the above-discussed conventional polymeric membranes and thus are able to perform diffusion within much smaller timescales. Moreover, the inventors have recognized pore sizes and pore densities for an atomically thin layer have a large effect on both the flow rate and selectivity for active layers used in diffusion based filtration application. Further, the inventors have developed manufacturing techniques to produce membranes having such pore sizes and pore densities to enable the desired fast diffusion rates with improved selectivity as well.

An atomically thin layer can, for example, be a layer of graphene, which is a one atom thick allotrope of carbon. An atomically thin layer may include multiple atomically thin layers (e.g., 2, 5, 10 layers, etc.), while nonetheless having a thickness comparable to that of an atomically thin layer. For example, an atomically thin layer may have a thickness between 0.1 nm and 10 nm, or between 0.3 nm and 5 nm, or between 0.345 nm and 2 nm. The theoretical thickness of a sheet of graphene is 0.345 nm, and so an atomically thin layer comprising a single layer of graphene would be expected to have a thickness of approximately 0.345 nm. Where an atomically thin layer comprises multiple atomically thin layers, layers may be stacked on one another and/or layers may be bonded to adjacent layers. In some cases, when multiple atomically thin layers are grown, they may be bonded to one another as a result of the formation process. These dimensions of an atomically thin layer have particular importance in performing the filtration techniques described herein, since in large part it is the thin nature of these materials that allow high permeance and high flow rates while maintaining better selectivity as compared to polymeric membranes.

As used herein, an “atomically thin layer” refers to a structure formed from one or more planar atomic layers of materials. Atomically thin layers, also known as two-dimensional monolayers or two-dimensional topological materials, are crystalline materials composed of a single layer of atoms. For example, a layer of graphene is typically a one atom thick allotrope of carbon, though multiple layers may also be present. Without wishing to be bound by theory, atomically thin materials typically have strong chemical bonds within a plane or layer, but have relatively weaker bonds out of the plane with neighboring planes or layers. Therefore, atomically thin materials typically form sheets of material that may be a single atom thick, i.e. monolayer sheets, to thicker sheets that include several adjacent planes of atoms. For example, an atomically thin layer and/or material may be considered to be a sheet or layer of material including one or more adjacent crystal planes extending parallel to a face of the sheet or layer. An atomically thin material may have a thickness corresponding to any appropriate number of crystal planes including sheets with a thickness corresponding to 1 atomic layer, or in some instances, a thickness that is less than or equal to 2, 3, 4, 5, or 10 atomic layers, or any other appropriate number of atomic layers. Further, depending on the particular type of atomically thin layer and/or material being used, an atomically thin layer may have a thickness between 0.1 nm and 10 nm, between 0.3 nm and 5 nm, or between 0.345 nm and 2 nm. The theoretical thickness of a sheet of graphene is 0.345 nm, and so an atomically thin layer comprising a single layer of graphene would be expected to have a thickness of approximately 0.345 nm. However, ranges both larger and smaller than those noted above are also contemplated as the disclosure is not so limited. Atomically thin materials may also be referred to as ultra-strength materials and/or two-dimensional materials as well.

For the sake of clarity, the embodiments and examples described below are primarily directed to the use of graphene. However, the methods and membranes described herein are not so limited. For example, appropriate atomically thin materials that may be used to form an atomically thin layer include, but are not limited to, hexagonal boron nitride, molybdenum sulfide, vanadium pentoxide, silicon, doped-graphene, graphene oxide, hydrogenated graphene, fluorinated graphene, covalent organic frameworks, layered transition metal dichalcogenides (e.g., MoS₂, TiS₂, etc.), two dimensional oxides (e.g. graphene oxide, NiO₂, etc.), layered Group-IV and Group-III metal chalcogenides (e.g., SnS, PbS, GeS, etc), silicene, germanene, and layered binary compounds of Group IV elements and Group III-V elements (e.g., SiC, GeC, SiGe), and any other appropriate atomically thin material. Additionally, in some embodiments the methods described herein may be applied to the production of thicker non-atomically thin membrane materials such as graphene containing larger numbers of atomic layers, graphene oxide containing larger numbers of atomic layers, metal organic frameworks, thin-layer atomic layer deposition of metal oxides (AlO₂, HfO₂, etc.), zeolites, and other appropriate materials as well.

According to some embodiments, an atomically thin layer may be disposed upon a substrate or other supporting structure that maintains the structural integrity of the membrane during use. The substrate may be porous so that molecules diffusing through the atomically thin layer may then diffuse through openings of the substrate. As such, a composite membrane may include an atomically thin layer disposed on a corresponding substrate either directly or indirectly depending on the particular application. Nonetheless, the combined effective thickness of such a composite membrane may still be several times smaller than that of conventional membranes, as discussed above.

According to some embodiments, pores may be formed in an atomically thin layer either prior to, or after, bonding the atomically thin layer to a substrate. As will be discussed below, various techniques may be applied to form pores in one or more atomically thin layers, and these techniques may be applied before said one or more layers are disposed upon a substrate or after the layers are disposed upon a substrate. In cases where the atomically thin layer comprises multiple atomically thin layers, pores may be formed in the layers as a group (e.g., when the layers are bonded to one another) and/or pores may be formed in the layers individually prior to stacking or bonding the layers together.

To distinguish an atomically thin layer, such as a nanoporous atomically thin layer, from a substrate to which the atomically thin layer is attached, in the description below an atomically thin layer may be referred to as an “active layer.” Together, the active layer and a substrate form a composite membrane.

According to some embodiments, pores formed in an active layer may be functionalized to enhance the selectivity of the composite membrane. For example, the pores might be functionalized such that they are hydrophobic or hydrophilic depending on the desired application. Specific forms of functionalization may include, but are not limited to, carboxyl groups, hydroxyl groups, amine groups, polymer chains (polyamide, polyethyleneglycol, polyamide, etc.), small molecules, chelating agents, macrocycles, and biomolecules (e.g., crown ethers, porphyrins, calixarenes, deferasirox, pentetic acid, deferoxamine, DNA, enzymes, antibodies, etc.). In some embodiments, the above noted functionalizations, as well as other appropriate functionalizations, may be used to modulate transport of a molecule or particle through graphene. For example, and without wishing to be bound by theory: 15-crown-5 preferentially binds sodium ions and may thus regulate its transport, or, it may regulate the transport of other ions or molecules in response to binding of a sodium ion; polyethyleneglycol may preferentially allow transport of only small hydrophilic molecules and ions; and polyamide may allow for the preferential transport of water. In alternative embodiments, only the pores may be selectively functionalized. For example, the pores can have different chemical groups depending on the method of pore creation and treatment due to the pores oftentimes being more reactive than the surface of the active layer. These differences can be used to selectively functionalize only the pores. Thus, embodiments in which the surface and/or pores of the graphene are functionalized are possible.

The disclosed methods of manufacture, and the resulting membranes, may be applied to any number of different applications. For example, some commercial applications of the described membranes include, but are not limited to: water purification to remove pathogens, organic molecules, and salts (desalination/softening); desalting of proteins; portable water filters; preconcentrators for liquid or gas samples for use in sensing applications; gas separation in energy applications such as natural gas separation (methane from carbon dioxide, hydrogen sulfide, and heavier hydrocarbons) and carbon sequestration; dialysis in biological research; medical implants for allowing only select molecules to go through (e.g., for sensor applications); separation of excess reactants from a reaction mixture; medical implants that allow only select molecules to pass through a membrane (e.g., for sensor applications); controlled drug release devices; and use in fuel cells as proton-selective membranes.

Moreover, it should be noted that the embodiments and examples described below are focused on method and systems for performing diffusion-based filtration, which differs from pressure-based filtration in a number of ways. First, sizes, uniformities, and number densities of pores formed in an active layer will differ in both cases. For example, in diffusion-based filtration processes the diffusive rate of a membrane relative to a particular species is proportional to D²/L where D is the pore size and L is an effective length of the membrane. In contrast, for pressure driven systems, the diffusive rate of a membrane is proportional to D⁴/L. Consequently, pressure driven flow may begin to dominate the operation of a particular membrane for larger pore sizes above a threshold pore size. For example, in one exemplary embodiment, a filtration membrane may include a porous substrate on which an atomically thin layer is disposed. The porous substrate may have a thickness of 10 um and a 200 nm mean pore diameter and the corresponding pores formed in the associated atomically thin layer may be less than or equal to 50 nm to provide selective diffusive transport of species across the atomically thin layer.

As noted above, the systems and methods described herein may be used to perform diffusion based filtration. Accordingly, solutions and/or gases disposed on either side of a filtration membrane may be agitated, stirred, or otherwise mixed to help reduce the presence of concentration gradients which may slow a diffusive filtration process. However, embodiments in which one or more solutions and/or gases located adjacent to a filtration membrane are not mixed are also contemplated.

Turning now to the figures, specific non-limiting embodiments are described in more detail. It should be understood that various features of the separately described embodiments may be used together as the current disclosure is not limited to the specific embodiments depicted in the figures and described below.

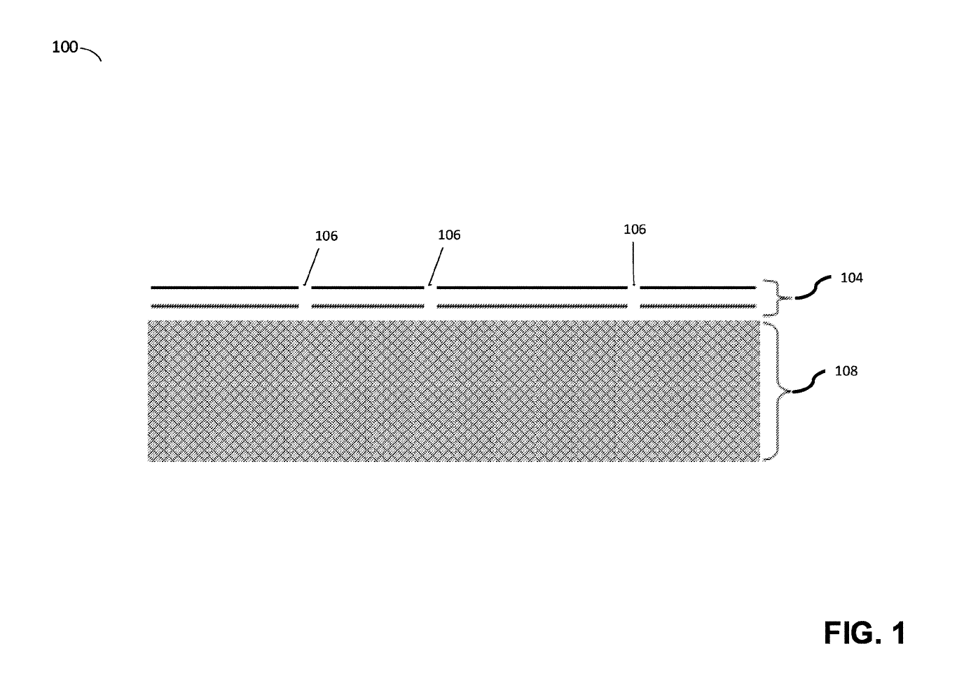

FIG. 1 is a schematic of a nanoporous atomically thin layer disposed upon a substrate, according to some embodiments. In the example of FIG. 1, a composite membrane 100 comprises an active layer 104 with angstrom or nanometer-scale pores 106 supported by a support substrate 108 that the active layer is disposed on. In some embodiments, substrate 108 may be a porous ceramic, polymeric, metal, or any other appropriate substrate. Additionally, in some instances, a substrate may include multiple layers. For example, a polycarbonate tracked etched membrane on which the active layer is disposed may rest on a sintered steel porous support. Additionally, an active layer may be transferred to other types of supports including polymeric membranes including, for example, asymmetric polyamide membranes used for reverse osmosis of brackish water or seawater. As discussed above, a composite membrane may comprise only a single porous atomically thin layer, though embodiments in which an active layer may comprise more than one such layer are also contemplated. For example, FIG. 1 depicts an illustrative example of one such embodiment that includes two stacked porous atomically thin layers 104 that are disposed on the substrate. In the depicted embodiment, the pores are aligned in the stacked atomically thin layers such that they pass from an external side of an outermost atomically thin layer to an opposing side of an innermost atomically thin active layer disposed adjacent to the supporting substrate thus provide fluid communication between opposing sides of the active layer. However, it will be appreciated that composite membrane 100 could also be produced with substrate 108 and a single atomically thin layer 104 as well.

As depicted in the figure, an active layer 104 may sterically hinder the transport of larger molecules on an upstream side of the membrane while permitting the transport of smaller molecules through the composite member. Additional mechanisms such as electrostatic and van der Waals interactions may also play a role in selectivity. The size and density of the pores in the active layer may be optimized for the particular application and the sizes of the constituent molecules, ions, particles, or other filtrate species (i.e. materials that pass through a filter) that are intended to pass through an active layer of the composite membrane. Since the active layer is atomically thin, resistance to flow can be much lower than that of other membranes, resulting in a much higher permeability. Additionally, as discussed above, multiple atomically thin layers may be stacked on one another which may help to cover imperfections in the underlying layers through which large volumes of all species in a gas and/or fluid mixture may flow which is elaborated on further below.

According to some embodiments, in some applications the durability of the membrane may be important, and therefore a protective coating may be applied to the active layer to ensure that the membrane will function effectively after careless handling or repeated use (not shown in the figure). Appropriate protective layers include, but are not limited to: polymers deposited by layer-by-layer assembly such as polyethyleneglycol, polyamide, polysulfone, polyanionic and polycationic polymers; zwitterionic molecules; and nanoparticles such as silver and titania nanoparticles. While not illustrated in the figure, such a protective layer may be disposed on an exterior surface of an active layer disposed on an underlying substrate.

According to some embodiments, pores 106 may be sized to select for particular species of molecules, ions, compounds, or other appropriate materials in a selection process, such as dialysis. The inventors have recognized and appreciated that pores having a diameter that is between 0.1 nm and 50, as well as between 0.1 nm and 10 nm, may be particularly useful for separating particular target species from one another using primarily diffusion based flow. For example, the approximate size of a protein molecule may be 1 nm, and the approximate size of potassium chloride ions (K⁺ and Cl⁻) is 0.6-0.7 nm. As such, pores having a size between 0.7 nm and 1.0 nm may be particularly effective at desalting an aqueous solution of KCl and a protein by separating the K⁺ and Cl⁻ ions from the protein molecules. Other illustrative molecular sizes and their relationship to desirable pore sizes are discussed further below. In some embodiments, pores of the active layer may have a mean pore diameter that is between 0.3 nm and 3 nm, or between 0.5 nm and 2 nm, 0.65 nm and 2 nm, or between 0.5 nm and 1.5 nm, or between 0.8 nm and 1.2 nm, or is less than 0.5 nm, or less than 1 nm, or less than 2 nm. Further, given the sensitivity of diffusion-based filtration processes to variations in pore sizes, in some embodiments, a corresponding standard deviation of pore diameters in an active layer may be between 0.05 nm and 0.5 nm or between 0.2 nm and 1 nm. Of course, embodiments in which the mean pore diameter and standard deviation are greater or less than those ranges noted above are also contemplated as the disclosure is not so limited.

According to some embodiments, pores 106 may have a number density selected to produce desirable diffusion rates through the active layer. The inventors have recognized and appreciated that it may be desirable to maximize the number density of pores in the active layer without disrupting the structure of the active layer (e.g., the lattice structure of a crystal such as graphene). However, depending on the non-uniformity of pore sizes, i.e. pore size standard deviation, it may be desirable to limit a number density of pores formed in an active layer to below a threshold number density for filtration applications involving diffusion to avoid a reduced selectivity of the resulting membrane during operation. Based on the above, a number density of pores formed in an atomically thin layer may be less than or equal to 10¹⁴ per cm², 5×10¹³ per cm², 10¹³ per cm², 10¹² per cm², 10¹¹ per cm², 10¹⁰ per cm², or any other appropriate number density. Correspondingly, a number density of pores formed in the atomically thin layer may be greater than or equal to 10⁹ per cm², 10¹⁰ per cm², 10¹¹ per cm², 10¹² per cm², or any other appropriate number density. The combination of the above ranges are contemplated including, for example, number density is between or equal to 10⁹ per cm² and 10¹⁴ per cm², 10⁹ per cm² and 10¹³ per cm², or any other appropriate combination of the above-noted ranges. Further, it should be understood that ranges both larger and less than those noted above are also contemplated as the disclosure is not so limited.

Referring again to FIG. 1, porous substrate 108 beneath the active layer 104 may provide structural support to the active layer and may also impede flow through imperfections in the active layer not eliminated by stacking multiple atomically thin layers within the active layer. These imperfections include unintentionally created cracks or nanometer scale holes in the active layer that might otherwise compromise the selectivity of the membrane. The porous support may provide resistance to flow through areas where large imperfections in the active layer exist, such that flow through the intended holes may still dominate the overall flow through the composite membrane instead of flow through the above-noted imperfections. For example, the porous substrate may be a polycarbonate track-etched (PCTE) membrane with pores having a diameter in the range 5 nm to 10 μm, and pores having lengths (e.g., the thickness of the substrate) in the range of 1 μm to 5 mm extending from one side of the porous substrate to an opposing second side of the porous substrate. In some embodiments, the porous substrate 108 may include pores having a diameter in the range 50 nm to 1 μm, or in the range 100 nm to 800 nm, or in the range 250 nm to 750 nm, or in the range 400 nm to 600 nm.

According to some embodiments, it may be desirable for the membrane to have a porous support with a resistance to flow approximately matching that of the active layer to limit leakage through defects and uncovered portions of the substrate. Alternatively, the flow resistance of the porous support may be selected to limit leakage through defects and uncovered portions of the substrate to a predetermined fraction of the flow through the active layer. Thus, appropriately selecting a flow resistance of the supporting substrate may help ensure that flow through the selective pores of an active layer is significantly larger than that through imperfections in the same active layer. In this context, a flow rate defined by the flow resistance may refer to diffusive transport, convective transport, electrokinetic transport, or any other appropriate transport mechanism. For a dialysis membrane, diffusive transport, and potentially electrokinetic transport, may be of concern. Further, flow resistance matching of an active layer and porous supporting substrate may be different for a diffusion-based application then for pressure-based applications. For example, a flow resistance of a substrate relative a corresponding active layer for a particular species may have a ratio such that diffusive flow dominates the behavior of the membrane performance as compared to pressure driven flow. For example, using a particular porous substrate having a particular flow resistance a corresponding atomically thin layer may have pores formed therein with pore sizes be less than an upper pore size threshold and/or greater than a lower pore size threshold to ensure that the composite membrane has a lower diffusive flow resistance than a corresponding pressure driven flow resistance. It should be understood that these upper and lower bounds may either be calculated using the relationships disclosed herein and/or experimentally measured as the disclosure is not so limited. For example, in one embodiment a graphene active layer is used with a polycarbonate track etched membrane with a thickness of 10 um and a mean pore diameter of 200 nm. In such an embodiment, the corresponding pores in the graphene, or other atomically thin layer, may have a mean pore size that is less than 50 nm to ensure diffusion based flow will dominate the flow behavior. Of course, embodiments in which different mean pore sizes and/or different types of porous substrates are used are also contemplated as the disclosure is not so limited.

Flow resistance of the individual components and/or an overall composite membrane may be measured by using a pressure difference to induce flow and measuring it in pressure driven systems. Alternatively, in diffusion driven system, flow resistances of the components may be measured by comparing the diffusion of a particular species through the support and comparing it with the know diffusivity of that particular molecule in that particular solution, e.g. Allura Red in water. Of course, in some embodiments, the above noted relative flow resistances of a substrate and associated active layer may be measured using hydrogen gas.

According to some embodiments, active layer 104 may comprise one or more layers of graphene. As discussed above, graphene is a one atom thick allotrope of carbon. Pores 106 may be formed in the layer(s) of graphene via etching and/or other suitable processes as discussed below.

In some cases, the active layer 104 may include one or more defects or tears. These defects or tears may be naturally occurring (e.g., lattice discontinuities in a crystal such as graphene) and/or may be produced (or exacerbated) as a result of the fabrication process of a composite membrane (e.g., when forming pores 106). Defects and tears can have at least two undesirable effects: first, they can increase the mean pore diameter in a manner that would reduce selectivity of the composite membrane; and second, in cases of very large defects or tears, they may provide a high diffusion rate pathway through the active layers, effectively “short circuiting” the open pores 106 of the active layer and dramatically reducing selectivity.

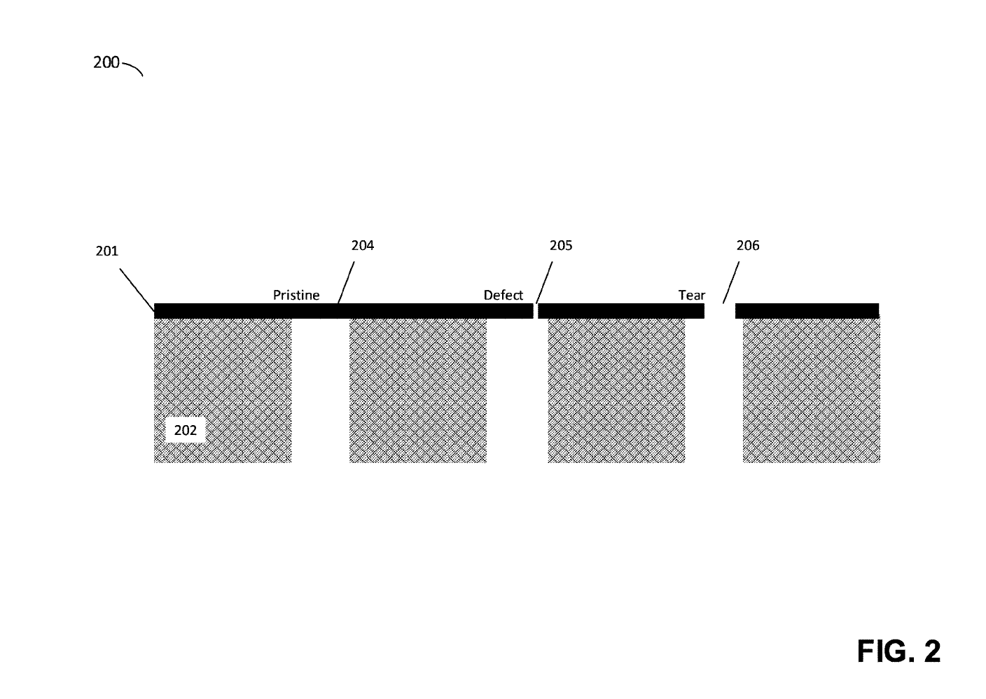

FIG. 2 is a schematic of a nanoporous atomically thin layer disposed upon a porous substrate and illustrates such defects and tears in the membrane, according to some embodiments. In the example of FIG. 2, composite membrane 200 includes a single atomically thin layer 201 on a porous substrate 202. It should be noted that, while neither FIG. 1 nor FIG. 2 should be considered as drawn to scale, FIG. 2 is of a different scale than that of FIG. 1, in that FIG. 2 illustrates pores of substrate 202.

As used herein, “defect” or “tear” will be understood by those of ordinary skill in the art to mean a portion of a component affecting flow, separation, and/or filtration in a way that is significantly different than the article as a whole, and/or different than the manner in which the article is ideally intended to perform. For example, defects can be lattice defects, tears, punctures, or the like. For example, a sheet of graphene having a discontinuity in the shared carbon ring structure due to an inherent result of a particular fabrication process, due to damage to the sheet defining a hole, or the like.

In the example of FIG. 2, a portion of the active layer 201 that is pristine, and without defect or tear is shown as 204. The region 204 of the active layer may contain any number of open pores, which are not shown in FIG. 2 for clarity. The active layer 201 also includes a defect region 205 and a tear (essentially presented as a large defect) region 206.

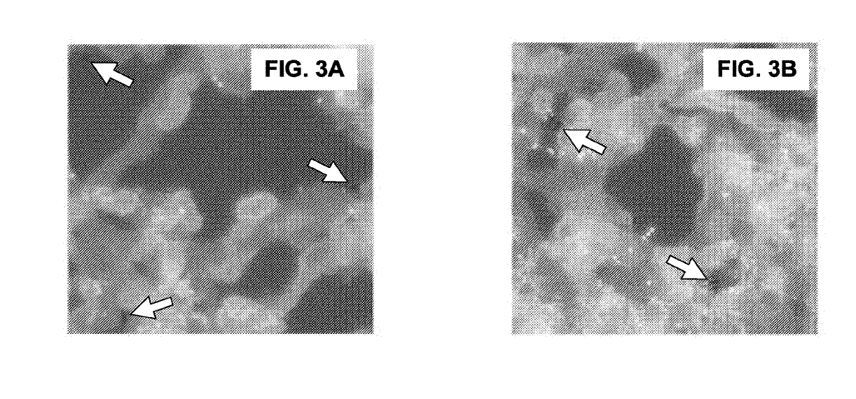

FIGS. 3A-B are high resolution scanning tunneling electron microscopy (STEM) images showing nanoscale pores in a hexagonal graphene lattice, according to some embodiments. In each of FIG. 3A and FIG. 3B, holes in the hexagonal graphene lattice having a size from sub-nanometer size to a few nanometers are identified with arrows.

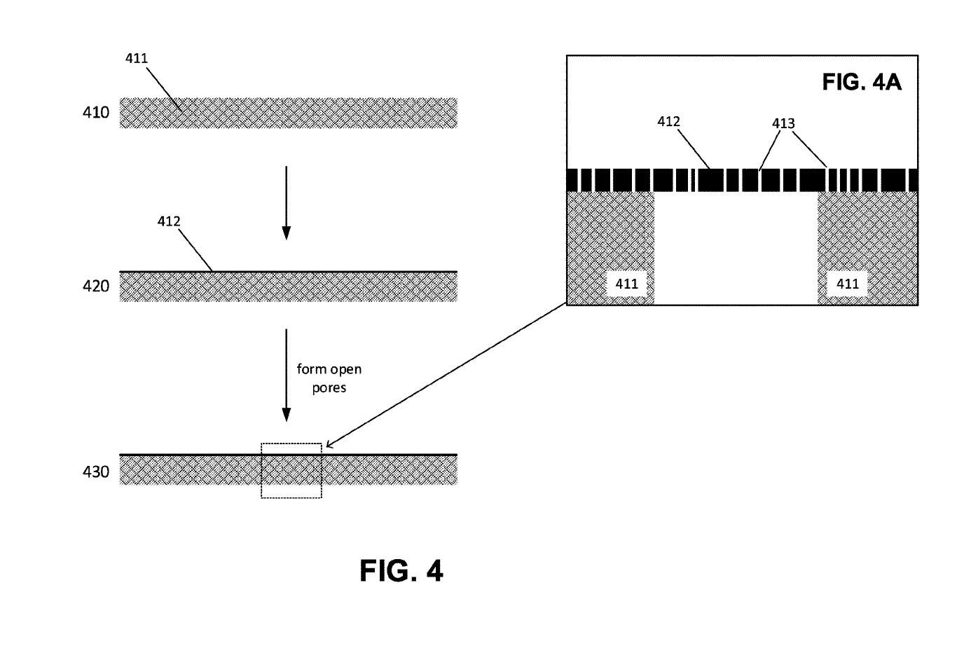

FIG. 4 illustrates a process of forming a nanoporous atomically thin layer disposed upon a porous substrate, with inset FIG. 4A showing a view of the surface of the membrane at a smaller scale, according to some embodiments.

In step 410 of FIG. 4, a porous substrate 411 is formed or otherwise obtained. As discussed above, such a substrate may comprise a polycarbonate track-etched (PCTE) membrane, a polydimethylsiloxane (PDMS) mesh, a porous ceramic, etc. In step 420, an atomically thin layer 412 is disposed onto the substrate 411. The atomically thin layer 412 may be formed on a separate substrate and then transferred onto the substrate via a suitable transfer mechanism, examples of which are discussed below. In step 430, pores are formed in the atomically thin layer 412. These pores are not visible in step 430 of FIG. 4 but are shown as pores 413 in inset FIG. 4A, which shows step 430 at a different scale. Of course, it should be understood that embodiments in which an atomically thin layer is grown on a substrate and pores are subsequently grown in both the atomically thin layer and underlying substrate to form a porous active layer and underlying substrate are also contemplated as the disclosure is not so limited.

According to some embodiments, processes for forming pores 413 whilst controlling for the size and number density of pores created in an active layer may include, but are not limited to, oxygen plasma etching, ion bombardment, chemical etching, gas cluster ion-beam bombardment, pulsed laser deposition, plasma treatment, UV-ozone treatment, or combinations thereof. In some cases, at least some of the pores 413 may be formed when the active layer is formed (e.g., growing graphene on a substrate, such as a copper substrate, with patterned defects). Once the pores are generated, their sizes and shapes can be further refined through chemical etching.

According to some embodiments, intrinsic defects or pores in the atomically thin layer 412 can be used in filtration processes. That is, pores of the atomically thin layer 412 used for filtration need not be limited to only those pores created through an active process such as etching. Intrinsic defects or intrinsic pores may, for example, occur naturally as a result of chemical vapor deposition (CVD), and/or may be introduced during synthesis of the atomically thin layer by controlling the substrates on which the membrane material(s) are grown. For example, a copper substrate for growing CVD graphene may be patterned, alloyed, or coated with nanoparticles to facilitate the introduction of defects of a desired size into the graphene during growth. Additionally, gases such as ammonia or nitrogen may be added during synthesis to create pores during the CVD process. Furthermore, the amorphous regions in graphene may contain a higher number of pores, which can also be used for filtration. Regardless of the manner in which the defects are created, after forming the defects in the one or more active layers, the defects may be selectively etched to a preselected size. Examples of appropriate etchants for these materials include, but are not limited to, concentrated nitric acid, mixtures of potassium permanganate and sulfuric acid, hydrogen plasmas, and hydrogen peroxide.

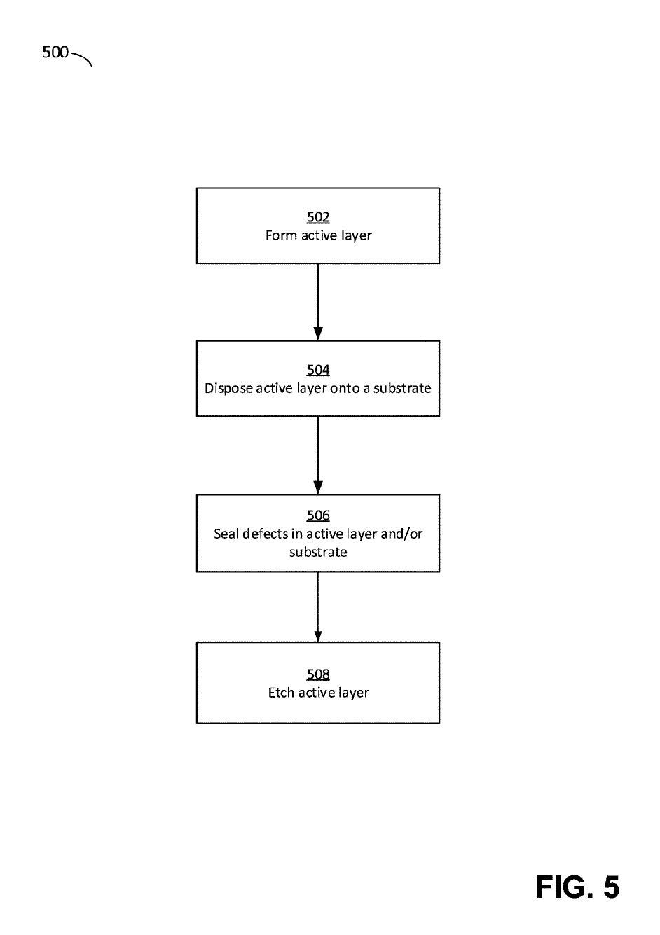

FIG. 5 is a flowchart of a method of producing a nanoporous atomically thin layer, according to some embodiments. In the example of FIG. 5, an active layer is formed prior to it being disposed upon a substrate. Defects in the active layer are sealed via a process to be discussed below. Finally, the active layer is etched to produce open pores of a desired size and number density.

Method 500 begins in act 502, in which an active layer is formed. As discussed above, an active layer may be an atomically thin layer formed from one or more atomically thin layers. Act 502 may comprise, for example, depositing a material on a temporary growth substrate (e.g., growing graphene on a metal substrate such as copper using chemical vapor deposition); chemical exfoliation; hydrothermal synthesis; thermal decomposition; Langmuir-Blodgett assembly; and/or any other appropriate process for forming an atomically thin layer as the disclosure is not so limited.

According to some embodiments, an active layer may be formed from graphene in the following manner. Graphene may be synthesized using chemical vapor deposition. Copper foil may be loaded into a quartz tube split furnace and heated in 60 standard cubic centimeters per minute (sccm) H₂ at about 0.5-1 Torr pressure (system base pressure ˜60-90 mTorr) to 1050° C. and annealed for 60 min. The copper foil may then be cooled to growth temperature (850-1050° C.) in 15 min. Then, 3.5 sccm CH⁴ may be introduced for 30 min in addition to H₂ and further increased to 7 sccm for 30 min. After the reaction the foil may be quench cooled to room temperature by opening the split furnace and using an air fan. However, while a particular manufacturing process for manufacturing graphene has been noted above, it should be understood that an atomically thin layer used in the processes and systems described herein may be manufactured using any appropriate method as the disclosure is not limited in this fashion.

In act 504, the active layer formed in act 502 is deposited onto a porous substrate to form a composite membrane. At this stage in method 500, the active layer may or may not include open pores and/or tears or defects, depending on the nature of the formation process in act 502. In some cases, processes applied in act 504 to transfer an active layer from a temporary substrate to a substrate to be used in a composite membrane may introduce pores, tears, and/or defects into the active layer.

In act 506, defects in the active layer and/or the substrate may be sealed as a way to control the mean pore size of the active layer and to avoid undesirably large openings that would severely reduce selectivity of the composite membrane, as discussed above. Such undesirable features of the composite membrane produced in act 504 may be addressed by depositing material into defects present with the active layer and/or into corresponding portions of a substrate associated with these defects to isolate and/or stop the flow through one or more defects. Illustrative examples of techniques to introduce material in such ways, such as interfacial polymerization, are discussed below.

In act 508, the active layer may etched in order to form pores. According to some embodiments, such etching may include oxygen plasma etching, chemical etching, other plasma based treatments, UV-ozone treatments, and/or any other appropriate etching process. As described further below, application of a selected etching technique may be performed continuously and/or intermittently as the disclosure is not so limited. Additionally, in instances where the active layer and/or substrate has been sealed prior to the etching process, the material deposited in the active layer and/or substrate may be compatible with the etching process such that it is not substantially etched during the etching process. For example a polymer deposited during an interfacial polymerization reaction described further below may be compatible with an oxygen etching process applied to an atomically thin layer to form pores therein.

Act 508 may include a step of monitoring or otherwise determining how the formation of pores is proceeding as a result of the etching process. For instance, act 508 may include performing spectroscopy (e.g., Raman spectroscopy) or another suitable technique to determine pore size and/or density. Such techniques may measure pore size and/or density directly (e.g., via imaging) or may measure pore size and/or density indirectly, such as by testing diffusion through the membrane, measuring mechanical strain of the active layer's lattice structure, etc.

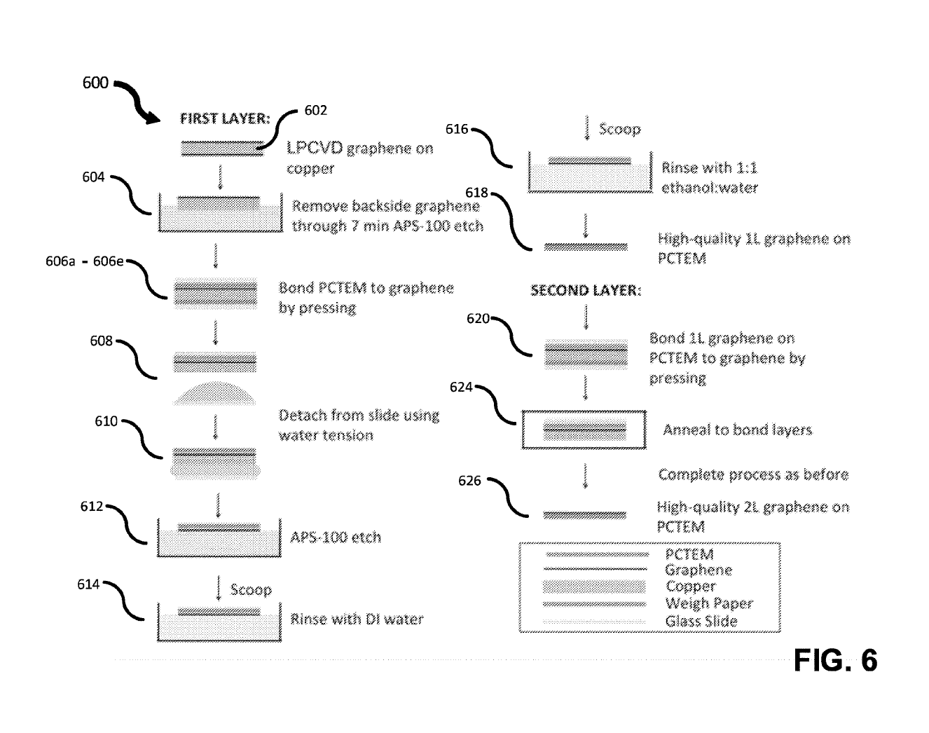

FIG. 6 depicts an illustrative process of forming multiple atomically thin layers of graphene upon a polycarbonate track etched membrane (PCTEM), according to some embodiments. While there are many different possible methods that may be used to place, or form, layered materials on a substrate, method 600 is provided as one illustrative example.

In the example of method 600, large areas of graphene with few pores and tears are transferred to a polycarbonate track etched membrane (PCTEM) with 200 nm pores using a pressing procedure. PCTEMs are manufactured by etching polycarbonate membranes after irradiation with high-energy particles. PCTEMs typically comprise straight pores that are isolated from neighboring pores. The pores may be cylindrical, but other shapes, such as conical or bullet shapes, are possible. Additionally, while the method is described with regards to a PCTEM, other porous substrates may also be used. The transfer procedure may include all of the subsequently detailed actions, or in some embodiments only a subset of the described actions may be used.

In the example of FIG. 6, a graphene layer formed using low pressure chemical vapor deposition (LPCVD) on copper foil is provided and cut to size in act 602. It should be understood, that other appropriate formation techniques may be used to provide the desired graphene layer. The graphene on the underside of the copper may be partially removed by etching in a copper etchant (e.g., ammonium persulfate solution trade name APS-100, from Transene Co.) for 7 min, then rinsing in deionized (DI) water at 604. The freshly-prepared sample may then be placed on a piece of weigh paper, which may in turn sit on a glass slide at 606a. A PCTEM may then be placed smooth-side-down on top of the graphene at 606b. Next, another glass slide may be placed on top of the PCTEM at 606c. To conform the PCTEM to the graphene, a glass pipet tube may be rolled back and forth over the top glass slide under moderate finger pressure at 606d. The pressing may conform the PCTEM to the contours of the graphene, adhering it to the graphene surface. After pressing, the top glass slide may be carefully removed, carrying with it the PCTEM and copper foil with the graphene at 606e. To remove the PCTEM with the graphene from the glass slide, the PCTEM with the graphene may be lightly placed over the top of a thin layer of DI water sitting atop a third glass slide at 608. The surface tension from the DI water may gently pull the PCTEM with the graphene off of the top glass slide and permit it to float on the surface at 610. The PCTEM with the graphene may subsequently be transferred to APS-100 for 5 min past the complete etching of the copper at 612. After etching, the PCTEM− supported graphene may be transferred to two subsequent DI water baths to rinse away residual etchant at 614, rinsed in a 1:1 water:ethanol bath at 616, and air-dried at 618. The final result of the above procedure is high-quality graphene on a porous PCTEM.

By repeating a modified version of the above procedure combined with annealing to bond the graphene layers, multiple layers of graphene can be independently stacked on one another. For example, a graphene layer formed as noted above, may be pressed onto another graphene layer at 620 and then processed similarly to 604-618 to produce a structure 626 with two graphene layers stacked on one another. This may increase the integrity of the membrane as cracks and defects in one layer may be covered by another. The addition of an annealing step 624 after pressing the two graphene layers into contact may encourage interlayer pi-bonding to occur, which may enhance the quality of the second layer coverage.

Other methods could instead be used to transfer graphene to a porous support substrate. These methods may include, but are not limited to: utilizing a sacrificial polymer layer as a temporary support while etching away the copper; directly transferring to a porous support using the evaporation of a solvent as a bonding agent; and etching away pores in the copper, effectively making the copper the porous support. Additionally, other sources of graphene could be used as an active layer, including graphene oxide, reduced graphene oxide, and epitaxial graphene. Further, if carefully controlled, spinning or vacuum filtration could be used to deposit one or more layers of a material on a porous support substrate to form the one or more graphene layers, or other appropriate active layers.

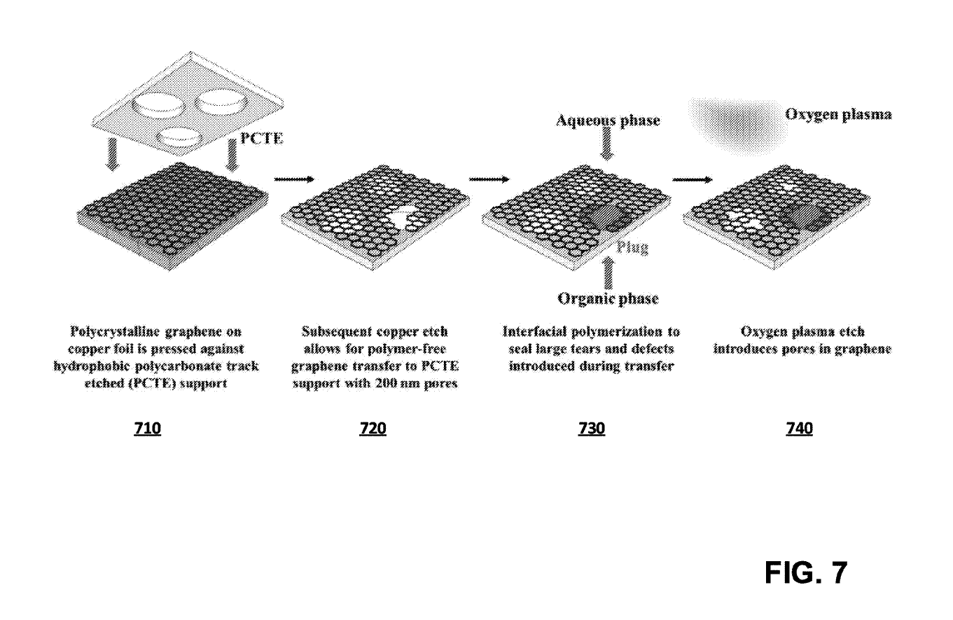

FIG. 7 depicts an illustrative process of forming a nanoporous atomically thin graphene membrane by etching with oxygen plasma, according to some embodiments. In the process of FIG. 7, in act 710, an atomically thin layer such as graphene is disposed upon a polycarbonate track etched (PCTE) membrane, or other appropriate porous support substrate, by pressing a copper foil, or other temporary carrier, including an atomically thin layer such as crossing against the polycarbonate track etched membrane. As illustrated in figure, the copper carrier may be etched using any appropriate etchant including, for example, ammonium persulfate (APS) solution to give a polymer free transfer of graphene on to PCTE support. away leaving the atomically thin layer transferred onto the polycarbonate track etched membrane, as discussed above.

Since the transfer process of acts 710-720 can introduce tears/defects in the atomically thin layer, these are sealed via interfacial polymerization (IP) in act 730. IP is described in greater detail below, but broadly speaking IP may be performed by sandwiching the graphene membrane between an aqueous solution of hexamethylene-di-amine (HMDA) in deionized water and an organic solution of adipoly chloride (APC) in hexane. Only in areas where the graphene is damaged/torn do the two solutions contact each other to form nylon 6,6 plugs that effectively seal the tears.

In act 740, once large tears in the graphene have been sealed, size selective pores are introduced by etching defects in the atomically thin layer using an oxygen applied to the composite membrane including the PCTE, atomically thin layer, and interfacial polymer plugs. The oxygen plasma selective etches the smaller intrinsic and/or induced defects present in the atomically thin layer that were not sealed using interfacial polymerization to form pores in the atomically thin layer, but leaves the remaining portions of the composite membrane substantially unetched. In such an application, the polymer plugs deposited onto the composite membrane may be formed from a material that is resistant to oxygen plasma etching as noted previously. While the oxygen plasma may simply be applied continuously to the composite membrane, in some embodiments, the oxygen plasma etching may be applied using one or more pulses. For example, a sequence of oxygen etching pulses may be applied for a period of time, then applied again after rest period has elapsed, then applied again after another off period, until a desired number of and/or size of pores have been formed. The applied sequence of pulses may include any number of pulses which may or may not be evenly spaced in time, and may or may not be of equal duration and/or magnitude. According to some embodiments, oxygen plasma etching pulses may be applied for durations per pulse that are between 5 seconds and 30 seconds, or between 10 seconds and 25 seconds, or approximately 15 seconds.

Again, the formation of pores in an atomically thin layer may be monitored via Raman spectra after each, or at preset numbers of, oxygen plasma pulses. The measured, Raman spectra, or other appropriate measurement, may be used to indicate the onset of pore growth and the associated strain in a

In one illustrative approach to act 740, an oxygen plasma process was applied to graphene transferred to a SiO₂ (300 nm)/Si wafer using 15 second pulses of an oxygen plasma with a 2 minute pause between successive pulses using a Harrick Plasma Expanded Plasma Cleaner PDC-001. The Plasma Cleaner had a maximum RF power of 30 W and was used to etch the atomically thin layer what about 0.6 W cm⁻² with a 500-600 mTorr oxygen gas partial pressure.

Oxygen plasma etching of a graphene lattice caused damage in the lattice from radicals in the oxygen plasma. A further increase in oxygen plasma time further increased the relevant spectra peaks along with broadening and distinct changes in the peaks. The spectral features was consistent with the formation of a mix of sp² and sp^{a} bonds caused by i) damage/attack from free radicals in the plasma and ii) functionalization of dangling bonds with oxygen. An increase in oxygen plasma time beyond 30 s did not appear to cause significant change in the Raman spectra features but the intensity noticeably decreases. High resolution scanning tunneling electron microscopy (STEM) images confirm the presence of sub-nanometer—few nanometers sized holes in the hexagonal graphene lattice (see FIGS. 3A-B).

In view of the above, oxygen plasma etching, and/or other forms of plasma etching, may be applied to an atomically thin layer, such as graphene, using a sequence of a individual etching pulses. A sequence of pulses may include any number of pulses which may or may not be evenly spaced in time, and may or may not be of equal duration. According to some embodiments, an etching pulse sequence may have a duration per pulse that is between 5 seconds and 30 seconds, or between 10 seconds and 25 seconds, approximately 15 seconds, and/or any other appropriate duration. Additionally, resting periods between etching pulses may be between or equal to about 30 seconds and 3 min., 1 min. and 3 min., about 2 min., and/or any other appropriate duration. Additionally, the oxygen plasma pulses may be applied using between or equal to about 0.1 W cm⁻² and 10 W cm⁻², 0.2 W cm⁻² and 5 W cm⁻², 0.05 W cm⁻² and 1 W cm⁻², and/or any other appropriate specific power. Of course, it should be understood that while particular pulse durations, magnitudes, and rest periods have been described above, any number of different type of etching pulse sequences and/or processes may be implemented to form pores in an atomically thin layer as the disclosure is not limited in this fashion.

Without wishing to be bound by theory, it is believed that applying a plurality of etching pulses as compared to a single continuous etching process may result in more selective etching of high-energy defects located within an atomically thin layer leading to a more uniform higher density number of pores. It is believed that pulsing of the plasma enables additional smaller defect creation with less growth of already existing defects as compared to continuous plasma etching. For example, and again without wishing to be bound by theory, an initial step during etching of an already existing pores includes removing functionalization atoms sitting on the pore edges (typically oxygen) by radicalizing them in the plasma which may be rate limited when pulse durations are sufficiently short resulting in the plasma reacting with exposed defects in the graphitic lattice instead which may lead to the creation and etching of a more uniform dense number of pores. However, for sufficiently long pulse times the oxygen present on the pore edges may be lost and the larger pores may then be etched as well.

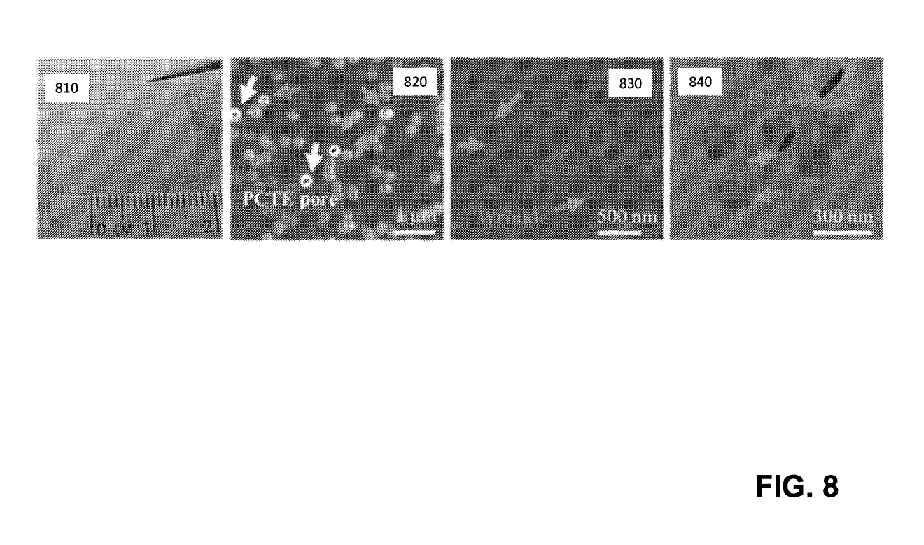

FIG. 8 illustrates surface features of a nanoporous atomically thin layer including pores formed with a pulsed oxygen etching sequence at various length scales, according to some embodiments. The example of FIG. 8 depicts graphene deposited onto PCTE, as described above. At the illustrated length scales, the nanoscale pores of the active layer are not visible, but the 200 nm PCTE pores may be observed through the graphene layer at 820 and 830. Moreover, some defects such as wrinkles and tears may be seen in 830 and 840, identified by arrow. Wrinkles are defects that do not themselves form an opening in the graphene but can easily give rise to subsequent tears in their location upon application of pressure or other forces during membrane fabrication.

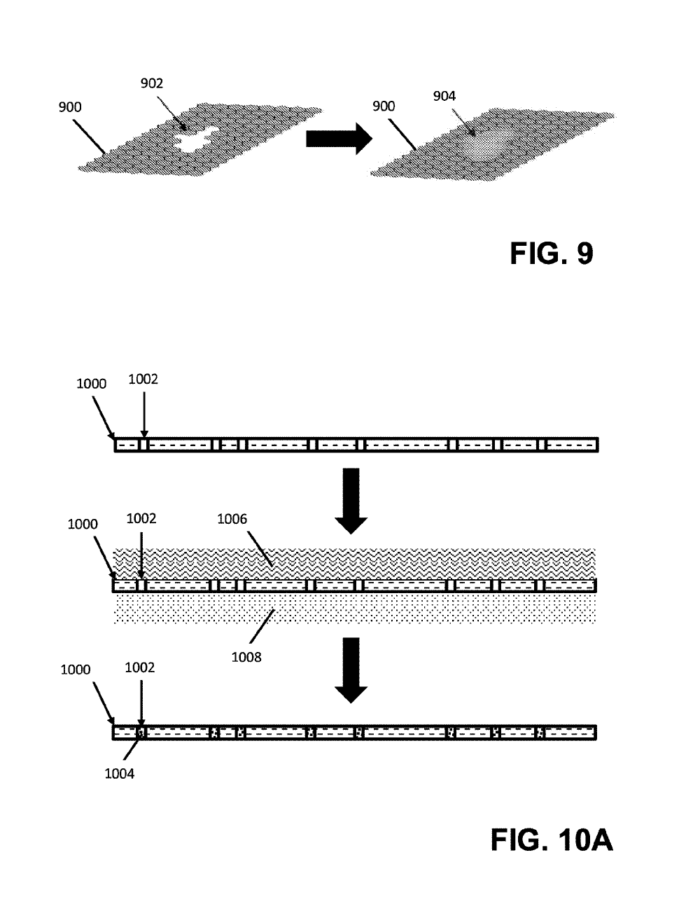

FIG. 9 illustrates filling of defects in an atomically thin layer of graphene, according to some embodiments. As discussed above, various stages in the fabrication process of a composite membrane may introduce defects into the active layer that are larger than is desirable. As such, processes to reduce the sizes of such defects may be applied before and/or after etching of pores has been performed.

As illustrated in FIG. 9, an active layer 900 includes a defect 902. A defect may be on the order of several nanometers up to, and possibly greater than several micrometers in size. In order to reduce flow of a desired species through the defect 902, for example hydrogen, a salt, ion, molecule or other species, a material is deposited into, or on top of, the defect 902 to form a plug 904. In some instances, the plug 904 may completely fill or cover the defect 902 to reduce a flow of a gas or liquid therethrough. However, in some instances, the plug 904 may only partially fill the defect 902. In such an instance, the defect 902 may be substantially filled such that a reduction in the open area of the defect is still sufficient to reduce a flow of a desired gas or liquid there through. As illustrated in the figure, the material used to form the plug 904 is preferentially deposited at the site of the defect 902 leaving the majority of the active layer surface free of the deposited material. As described previously, the material used to form the plug 904 may be deposited using an interfacial reaction. However, embodiments in which the material is deposited using other methods including, but not limited to, atomic layer deposition and/or chemical vapor deposition are also contemplated.

In embodiments using an interfacial reaction, a polymer, mineral, or any other solid deposit capable of reducing the flow of a desired gas or liquid is formed using a self-limiting chemical or precipitation reaction at the interface between two separate phases containing reacting monomers or components. Without wishing to be bound by theory, wherever the two separate phases contact one another, they form or precipitate the desired material. Therefore, by controlling the location of an interface between these two phases relative to the active layer, it is possible to control the location at which the material is formed or precipitated. For example, the interface may be located either on a surface of the active layer or within the active layer such that the deposited material is deposited on, or in, the defects themselves. Additionally, to facilitate manufacture and use of these membranes, the deposited material used to seal the defects may be insoluble in the first phase, the second phase, and/or a phase that the membrane will be subjected to during use.

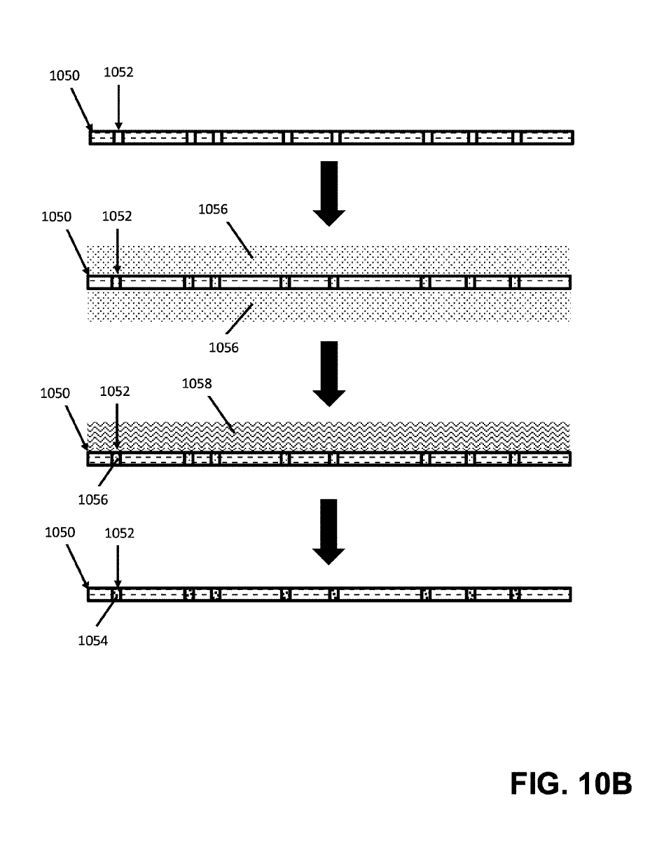

One such embodiment is illustrated in FIG. 10A which depicts an active layer 1000 including a plurality of defects 1002. The active layer 1000 is arranged such that a first phase 1006 is located on one side of the graphene layer and a second phase 1008 is located on an opposing second side of the active layer. As noted above, the first phase reacts with the second phase to form a precipitant or other product at their interface. If the two phases are not appropriately controlled, the interface between the phases may be located past a surface of the active layer 1000 and the material formed may not be deposited in the desired locations. Parameters that may be used to control the location of the interface include, but are not limited to, a pressure on either side of the active layer, a surface tension of the phases with the active layer and/or support substrate, a functionalization of the active layer and/or support substrate, concentrations or pressures of components in the phases, choice of solvent if performed in liquid phase or choice of background inert gas if performed in gas phase, and a radius of the support substrate to name a few. For example, and without wishing to be bound by theory, functionalizing one side of the active layer to be hydrophobic and the other side to be hydrophilic may be pin the interface at the plane of the active layer. By appropriately using the above-noted control parameters, the interface between the two phases may be located either in, or on a surface of the active layer 1000. Thus, the reaction, and the deposited material, may be restricted to places where holes, cracks, or other defects 1002 in the active layer allow the two phases to come into contact. The material formed or precipitated at these locations seals the defects 1002 with plugs 1004. Because the reaction is restricted to where the defects are located, the remaining portion of the active layer 1000 may be substantially free from the deposited material. Selective nanopores, or pores with other desired sizes, can then be introduced into the active layer to create a highly selective filtration membrane.

In embodiments similar to the one discussed above, the location and ability to seal a membrane using certain types of interfacial reactions may depend on the relative concentrations of the reactants. For example, the interfacial reaction of reactants having homobifunctional end groups (e.g. one monomer with amine end groups and another with acyl chloride) occurs where the fluxes of the two monomers have the correct stoichiometry. In the instance of aqueous and organic phase monomers, the aqueous phase monomer is typically soluble in the organic phase, and the polymer is deposited in the organic phase. Without wishing to be bound by theory, if the monomers are denoted by x-A-x and y-B-y where x and y are reactive groups, the monomer to formed would be -A-B-A-B-. However, if the number of B monomers is much greater, for example more than twice, the number of A monomers at a particular location, the A monomers will tend to react with the excess B monomers to yield y-B-A-B-y molecules that are unable to form longer polymer chains. Therefore, the polymer will form only when the fluxes of the reactants are approximately matched to form a stoichiometric mix of reactants. While a reaction for monomers include two reactive groups have been described above, the use of a stoichiometric mix of reactants to facilitate the desired interfacial reaction may be applied to monomers having more than two reactive groups as well as other types of reactants though the relative flux ratios of the reactants may be somewhat different for different reactants.

In view of the above, if the fluxes of reactants used in an interfacial reaction are mismatched, the resulting polymer, or other material, may form outside the composite membrane or it may not form at all. For example, if graphene with a 5 nm defect is suspended on a polycarbonate pore membrane with 200 nm diameter pores, and an aqueous monomer solution x-A-x is introduced on the graphene side, it will have insufficient flux compared to the monomer y-B-y introduced on the polycarbonate track-etched membrane side to form a stoichiometric mix of reactants within the composite membrane. As a result, both reactive groups of the monomer will be consumed and the result will be primarily the formation of y-B-A-B-y instead of a polymer inside of the composite membrane. However, if the flux of reactants within the composite membrane is controlled by appropriately controlling the transport resistances of the support filter versus the defects in the atomically thin active layer the product from the mixture of the various reactants may be deposited within the composite membrane. Therefore, in some embodiments, the transport resistance of a supporting filter may be greater than or equal to the transport resistance of defects located within an active layer, as measured using at least hydrogen gas, to facilitate formation of a stoichiometric mix of reactants within a composite membrane. For example, in the above case of an active layer having 5 nm defects, a polycarbonate track-etched membrane with smaller 10 nm pores will decrease the flux of monomer B so that the interfacial polymerization will be located within the composite membrane and will favor the formation of the desired polymer. Alternatively, in some embodiments, a similar result may be obtained by increasing the concentration of A and/or decreasing the concentration of B to provide the desired flux of reactants within the composite membrane.

While several specific embodiments to control the flux of reactants are described above, it should be understood that any appropriate combination of transport resistances of the active layer and/or support as well as the relative concentrations of reactants in the various phases may be used to provide a stoichiometric flux of reactants within the composite membrane to produce the desired interfacial reaction.

It should be noted that the interfacial reactions may be performed using any number of monomers having two or more reactive groups. For example, in some embodiments, an interfacial reaction of a polyamide may be performed using monomers such as amines and acyl chlorides. Appropriate monomers that may be used include, but are not limited to, trimesoyl chloride, polyhedral oligomeric silsesquioxane amine, phenylenediamine, propane-1,2,3-triamine, and adipoyl chloride.

In some instances, it may be desirable to perform an interfacial reaction without providing a stoichiometric flux of reactants within a composite membrane. Therefore, in some embodiments, reactions that do not require a stoichiometric mixture of reactants to form the desired interfacial reaction may be used. For example, a phase including monomers, soluble polymers, and/or soluble molecules may be located on one side of an active layer of a composite membrane, and an agent that causes polymerization or precipitation of the monomers, soluble polymers, and/or soluble molecules may be located on the other side of the composite membrane. Depending on the embodiment, the molecules may precipitate or polymerize due to pH, the presence of a solvent, the presence of catalysts, the presence of polymer chain growth initiator, or any other appropriate type of agent. In one specific embodiment, Poly(lactic acid) (PLA) is soluble in acetonitrile but not in water. Therefore, introducing PLA in acetonitrile on one side and water on the other side of a composite membrane will cause PLA to precipitate inside the composite membrane. In yet another example, the formation of polyaniline in the presence of an oxidant [O] is as follows: n C₆H₅NH₂+[O]→[C₆H₄NH]ₙ+H₂O. Consequently, an oxidant such as ammonium persulfate may be introduced on one side of a composite membrane and the monomer may be introduced on the other. In yet another example, polypyrrole may be formed in a composite membrane using the oxidation of pyrrole using ferric chloride in methanol. Reactants having multiple functional groups are also preferable in this regard due to lesser sensitivity to stoichiometry.

In cases where the porous support membrane has interconnected pores, it is desirable to localize a thin interfacial polymerization layer in the plane or close to the plane of the atomically thin layer (i.e. at the surface) rather than within the porous support. Interfacial polymerization using trimesoyl chloride, polyhedral oligomeric silsesquioxane amine, phenylenediamine, is known in the field to form such layers. Further control is possible through appropriate control of wetting and localization of the interface to control the location of the polymer. For example, dip-coating of the membrane in one solution that soaks into the membrane, followed by dipping in another solution to form the polymer, is a well-known method to form the polymer at the surface. Reactants with high reactivity and low diffusivity (high molecular weight) such as polyhedral oligomeric silsesquioxane amine are also known to form a thin (˜30 nm) thick layer.

FIG. 10B depicts another embodiment of using an interfacial reaction to seal an active layer 1050 including a plurality of defects 1052. In the depicted embodiment, the active layer 1050 is sequentially exposed to a first phase 1056 and a second phase 1058. For example, as depicted in the figure, the active layer 1050 may be dipped into the first phase 1056 such that the first phase 1056 is wicked into the defects. However, in some embodiments, the first phase 1056 may simply adhere to the surface of the active layer 1050 at the locations corresponding to the plurality of defects 1052. Regardless of how the first phase 1056 is held on the active layer 1050, when a side of the active layer 1050 is exposed to the second phase 1058, the two phases react to form plugs 1054 at the plurality of defects. While a particular arrangement for serially exposing the active layer to the separate phases has been depicted in the figures and described above, it should be understood that other arrangements for serially exposing the active layer are also possible.

Depending on the particular embodiment, the two reactive phases might be in the same state of matter, or different states of matter as the current disclosure is not so limited. For example, both the first phase and the second phase might be liquid. In another embodiment, one of the phases might be in a liquid state and/or a liquid phase that contains a reactant which reacts with a gas to produce the desired material. In such an embodiment, the liquid phase may be provided on one side of the active layer using any appropriate method such that it forms a plug when it comes in contact with the gaseous second phase at the open pores and defects of the active layer. Since graphene, is known to be impermeable to most gases in its defect-free state, this method should be relatively easy to implement as long as the pressure difference across the membranes is adequately controlled. In yet another embodiment, both the first phase and the second phase are gaseous phases.

The concept of performing an interfacial reaction to plug a plurality of defects in an active layer can be implemented using any number of different types of reactions including, but not limited to, precipitation reactions and interfacial polymerization reactions. Additionally, these reactions might be performed using two immiscible phases which may be enable the formation of highly stable and reproducible interfaces. For example, an interfacial polymerization reaction using two immiscible phases may be used to produce a highly stable polymer layer that is several nanometers thick to seal the defects and reduce or eliminate reducing or eliminate species transport across the defects where the material is deposited. Additionally, depending on the particular interfacial reaction, material may be deposited to reduce the flow through an associated defect on the size scale of about 1 nm to several micrometers or more. While there are benefits to using two immiscible phases, embodiments in which an interfacial reaction is produced using two miscible phases are also contemplated.

While interfacial reactions may be performed using immiscible fluids, it should be understood that an interfacial reaction may also be performed using miscible fluids, or even the same fluids. These fluids may be introduced on either side of a composite membrane including an active layer, and in some embodiments a support membrane, that hinders mixing of the two fluids so that the stoichiometric fluxes of the reactants occur within the composite membrane. For example, if the graphene, or other active layer, on a support membrane has few defects, introducing monomers in miscible fluids on either side of the composite membrane will lead to polymerization provided the fluxes yield the correct stoichiometry within the composite membrane.

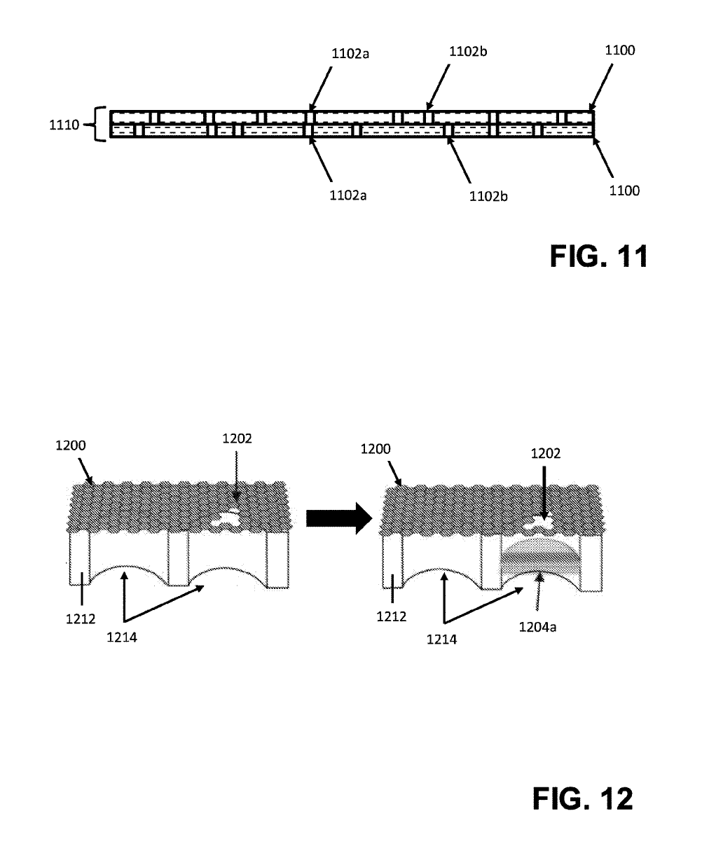

The embodiments described above were directed to sealing membrane active layers that included a single layer. However, techniques for sealing membranes is not limited to sealing defects in a single layer. Instead, the disclosed methods are capable of use on a membrane active layer including any number of layers. For example, FIG. 11 depicts an active layer 1110 that includes two individual active layers 1100. These individual active layers 1100 include a plurality of defects. In some instances, the defects are aligned with one another as depicted by defects 1102a, and in other cases, the defects are unaligned with one another as depicted be defects 1102b. The aligned defects 1102a permit material to pass through a membrane without selectivity. In contrast, the unaligned defects 1102b are blocked from permitting material to pass through the membrane by the adjacent pristine active layer 1100. One embodiment in which multiple individual active layers 1100 might be included to form an overall active layer 110 is when the active layer is applied to a supporting substrate. More specifically, providing a plurality of active layers may advantageously increase the covered area of the substrate because when a plurality of active layers of the same size and shape are placed on a substrate each will be randomly misaligned. However, it is highly improbable that any would be misaligned in exactly the same way. Therefore, some of the area of the substrate left uncovered by one active layer would likely be covered by subsequently placed active layers. Consequently, the uncovered area of the substrate may be reduced when a plurality of active layers are used. Other applications of multiple active layers are also possible. Additionally, while the individual active layers 1100 have been depicted as being in direct contact, in some embodiments, intermediate layers may be positioned between these adjacent active layers. Appropriate intermediate layers include: chemical cross-linkers with reactive terminal groups such as diazonium; different polymers such as poly(dimethylsiloxane), polycarbonate, and polyamide; layers of atomic layer deposited material such as alumina and hafnia; and other appropriate materials.

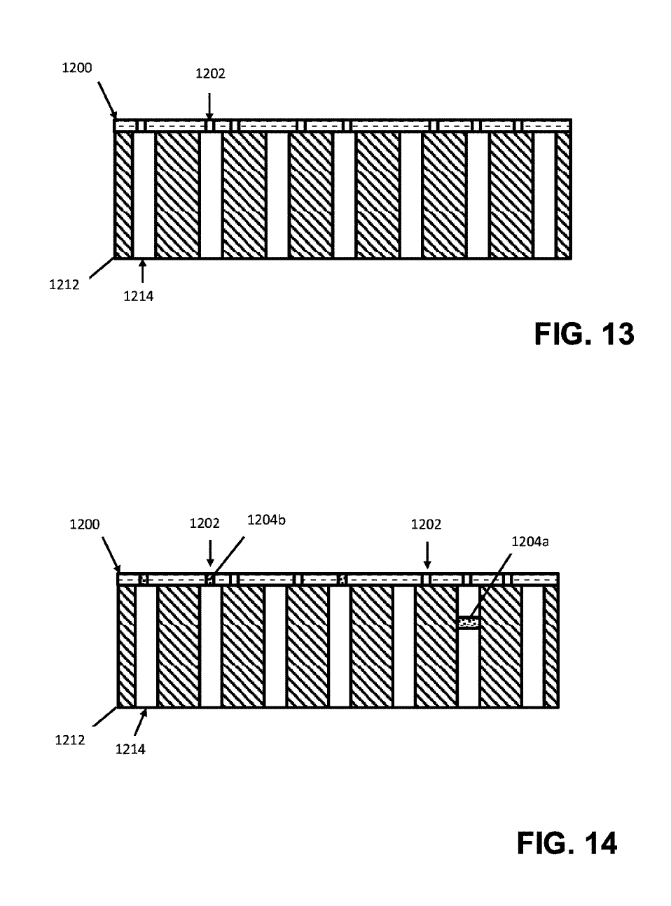

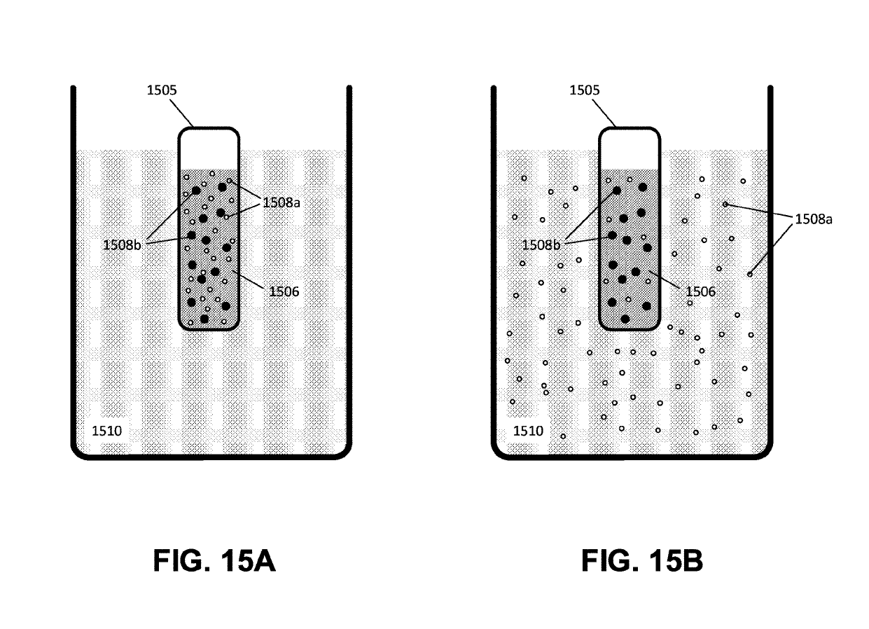

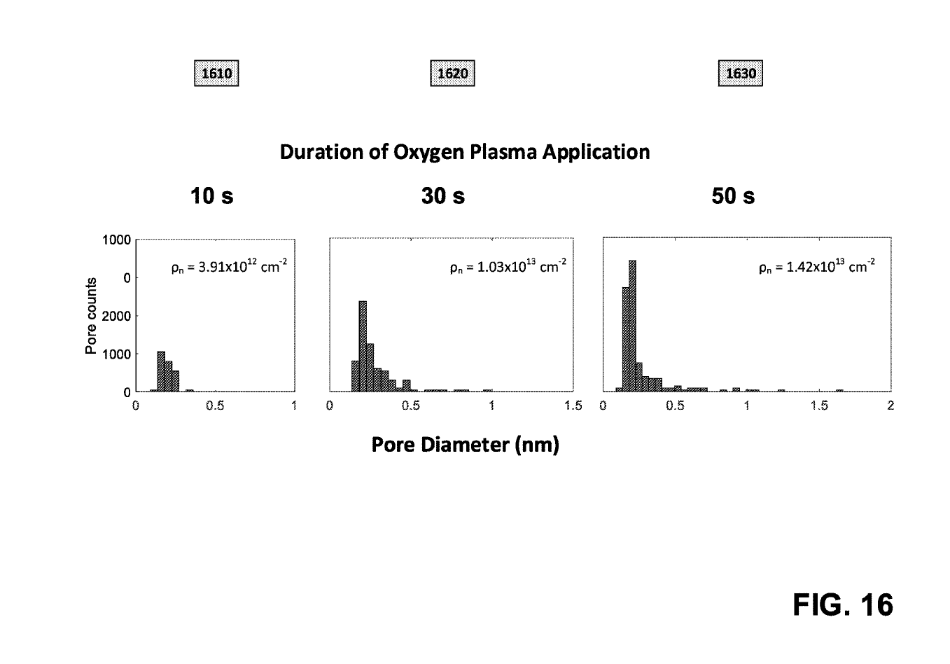

FIGS. 12-14 depict embodiments of an active layer 1200 including a plurality of defects 1202 disposed on a porous substrate 1212. The porous substrate includes a plurality of pores 1214. As depicted in the figures, the pores 1214 are aligned pores similar to a track-etched membrane. However, porous substrates including unaligned random pore networks are also possible. For example, graphene based filtration membranes, and other similar membranes, may be combined with a variety of supporting substrates including, but not limited to, porous ceramics, porous metals, polymer weaves, nanofiltration membranes, reverse osmosis membranes, ultrafiltration membranes, brackish water filtration membranes, or any other appropriate substrate.

Depending on the particular embodiment, the porous substrate disposed beneath the active layer may provide structural support to the membrane and may also impede flow through defects present in the one or more graphene layers that are not occluded, or otherwise mitigated. The porous support may provide sufficient resistance to flow through areas where large imperfections in the graphene exist, such that flow through the intended pores may still dominate the overall flow through the composite membrane. For example, the porous support may be a polycarbonate track-etched membrane with pore diameters in the range of 5 nm to 10 μm, and pore lengths (i.e. support layer thickness) in the range of 1 μm to 5 mm. Alternatively, the porous support might be a ceramic support with pores in the size range of 10 nm to 10 μm, and a thickness in the range of 100 μm to 10 mm. Furthermore, the support structure itself may include multiple layers. For example, the polycarbonate layer may rest on a sintered steel porous support. Furthermore, it should be understood that the graphene may be disposed on any other appropriate membrane or substrate. For example, asymmetric polyamide membranes used for reverse osmosis of brackish water or seawater might be used. In such an embodiment, the pore sizes of the membrane may be less than 10 nanometers or less than 1 nanometer.

FIGS. 12-14 illustrate the application of an interfacial reaction to seal a plurality of defects 1202 in an active layer 1200 disposed on a substrate 1212. As illustrated in the figures, depending on where the interface between the two reacting phases was located the defect 1202 may either be sealed by plugs 1204b located in, or on, the defects themselves, or the defects 1202 may be sealed by a plug 1204a corresponding to material deposited in a pore 1214 of the substrate 1212 that is associated with the defect. As noted above, the location of the interface may be controlled in any number of ways. Therefore, it may be possible to selectively form plugs in the active layer 1200 itself and/or in the associated pores 1214 of the porous substrate.

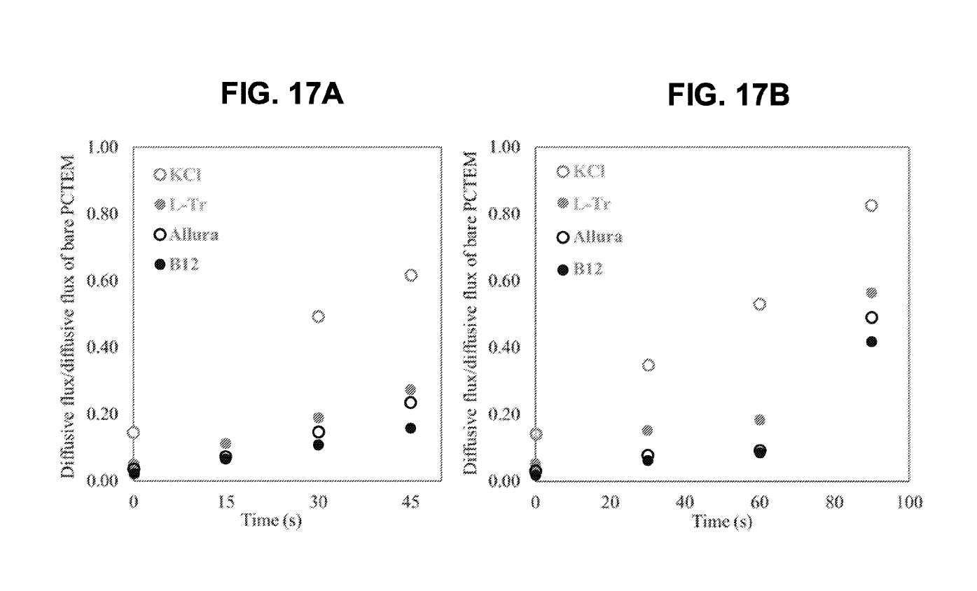

FIGS. 15A-B illustrate a dialysis process that may be implemented using a nanoporous atomically thin layer, according to some embodiments. In the example of FIGS. 15A-B, a biological dialysis process is performed to separate two species of molecular solutes 1508a and 1508b in a solution 1506. It will be appreciated that other arrangements of a nanoporous atomically thin layer (NATM) to perform filtering may also be envisioned, and that the illustrative example of FIGS. 15A-B is provided as merely one approach. For instance, as an alternative to the configuration of FIGS. 15A-B, two vessels may be separated by a wall comprising a NATM, where the vessels consist of a feed side vessel and a permeate side vessel.

In FIG. 15A, the solution 1506 is placed in a buffer solution 1510. Vessel 1505 has a surface of which at least part includes a composite membrane comprising a nanoporous atomically thin layer, as described above. For instance, one or more sides of the vessel may include a nanoporous atomically thin layer, such as but not limited to, one or more layers of graphene disposed upon PCTE. Irrespective of the particular materials used in the nanoporous atomically thin layer, pore size and density in the active layer of the membrane may be selected to allow diffusion of the comparatively smaller solute species 1508a whilst restricting diffusion of the comparatively larger solute species 1508b. As shown in FIG. 15B, at a later time, the species 1508a has largely diffused out of the vessel and has reached an equilibrium state with equal concentration of 1508a inside and outside of the vessel, while species 1508b remains within the vessel.

As a non-limiting example, solute species 1508a may be a salt or other small molecule and solute species 1508b may be a protein. In this case, the diameters of pores of the nanoporous atomically thin layer that makes up at least part of the vessel 1505 may be selected to let the small molecules (e.g., sized between 0.6 nm and 1 nm) diffuse through whereas larger protein molecules (e.g., sized between 1 nm and 2 nm) are restricted from diffusion. For example, the pores may have a mean diameter of between 0.8 nm and 1.2 nm, or between 0.9 nm and 1.1 nm, or between 0.7 nm and 1 nm.

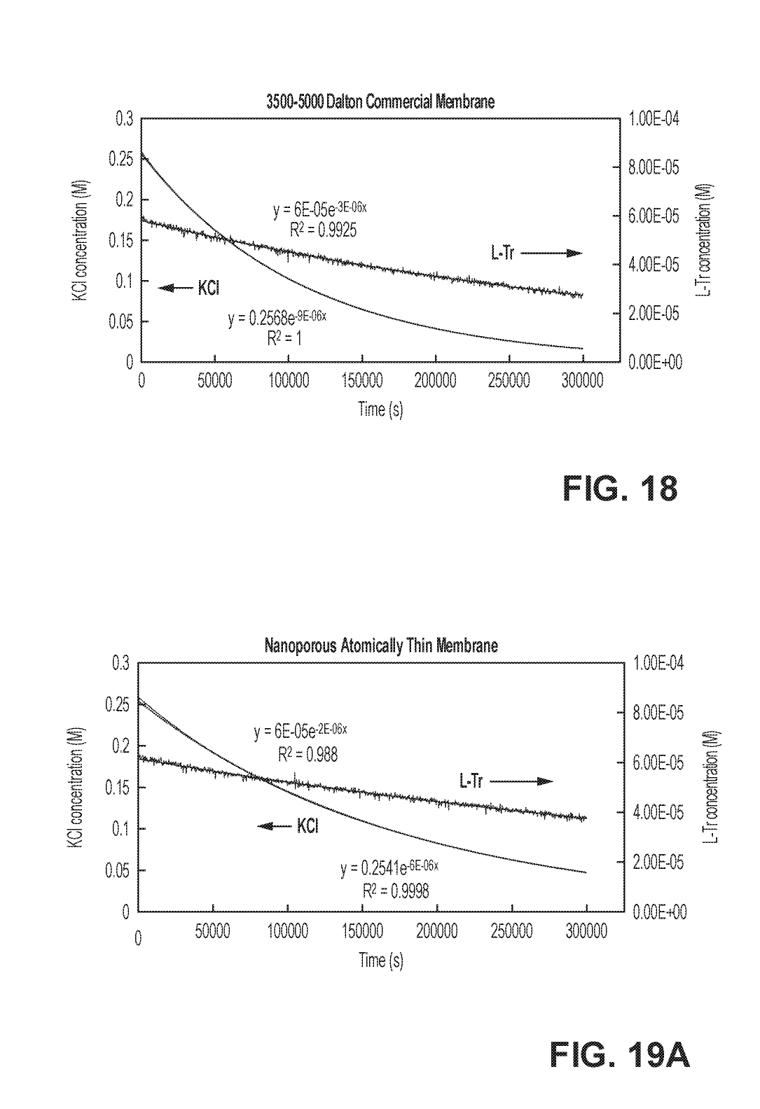

As discussed above, an oxygen plasma may be applied to an atomically thin layer of graphene to etch open pores in the graphene. FIG. 16 depicts experimental data showing histograms of pore sizes and number density as a function of the total duration that oxygen plasma pulses have been applied to the substrate, 10 sec, 30, sec, and 50 sec, according to some embodiments.

In the example of FIG. 16, histograms showing distributions of pore diameters within graphene for various different exposures to an oxygen plasma application are shown. The first histogram 1610 illustrates the results of applying oxygen plasma to the graphene for a duration of 10 seconds. Such an application produces graphene having pores with a mean pore diameter of around 0.25 nm and a number density ρₙ=3.91×10¹² cm⁻². As can be seen, with increasing duration of the oxygen plasma application, the number density increases whilst the mean and variance of the pore diameter both increase which as elaborated on below results in lower selectivity for the atomically thin layers especially when used for diffusion based applications.

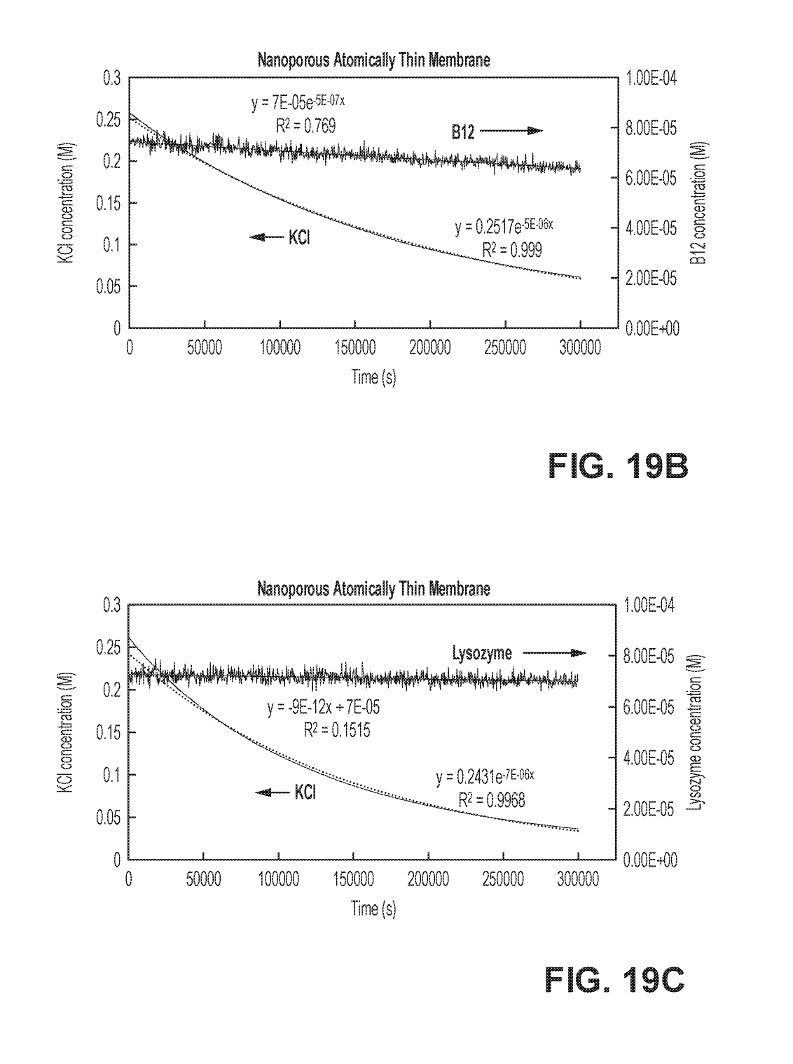

FIGS. 17A-B depict experimental data illustrating the selectivity of a nanoporous atomically thin layer against four different molecule types based on different oxygen plasma application techniques and durations, according to some embodiments. In the example of FIGS. 17A-B, pore creation was performed in a graphene membrane using oxygen plasma pulses as described above after sealing large tears via interfacial polymerization. Normalized diffusive flux relative to bare PCTE is plotted as a function of plasma pulse time (15s pulse, 500 mTorr) for Potassium chloride (KCl, K+ and Cl— ˜0.66 nm), Allura red (˜1 nm), L-Tryptophan (˜0.7-0.9 nm) and Vitamin B12 (˜1-1.5 nm).

The difference between FIG. 17A and FIG. 17B is that the data in FIG. 17A was produced from measurements performed on a single membrane—that is, the membrane underwent oxygen plasma for 15 seconds, was removed and its transport properties measured, then replaced to undergo an additional 15 second pulse of oxygen plasma, etc. For the data in FIG. 17B, each duration shown in the figure represents a different membrane to which a particular sequence of 15 second pulses was applied to form pores in the atomically thin layers. For example, one membrane was exposed to two 15 second pulses of oxygen plasma (shown as the 30 second data points) whereas a different membrane was exposed to four 15 second pulses of oxygen plasma (shown as the 60 second data points), etc. The purposes of performing these two measurements was to account for damage to the membrane that can occur during clamping and declamping during a plasma etching procedure. Specifically, the clamping and de-clamping of the same membrane over multiple measurements may introduce a small number of tears in the graphene which can be avoided by using a separate membrane for each plasma time.

FIG. 17A shows an increase in KCl transport with increasing plasma time but the rate of increase in KCl transport is distinctly higher than that of L-Tr, Allura and B12 indicating the presence of a majority of sub-nanometer pores. Here, some amount of transport is also attributed to tears in the graphene due to de-clamping and re-clamping between successive measurements on the same membrane. FIG. 17B shows a similar increasing trend of KCl flux with an increase in plasma etching time. However, the flux of other molecules is distinctly lower than for the corresponding times in FIG. 17A. We observe the highest difference in flux ratios between KCl and other molecules for a plasma time of 60 s. For 90 s oxygen plasma we observe a noticeable increase in the flux of other molecules in addition to KCl (FIG. 17B) indicating that pores with diameters larger enough to accommodate passage of these larger molecules are beginning to dominate flow and hence are less efficient at inducing separation. As such, for this approach an oxygen plasma application of around 60 seconds, for these specific etching parameters, may produce the greatest selectivity while producing a desirably fast rate of diffusion. Again, this behavior may be due to the non-uniformities present in the pore size where a relatively smaller number of larger pores may be dominating flow in this diffusion based application reinforcing that it is desirable to balance a combination of pore size, number density, and pore size uniformity to provide both a desired flux rate and selectivity for a particular membrane.

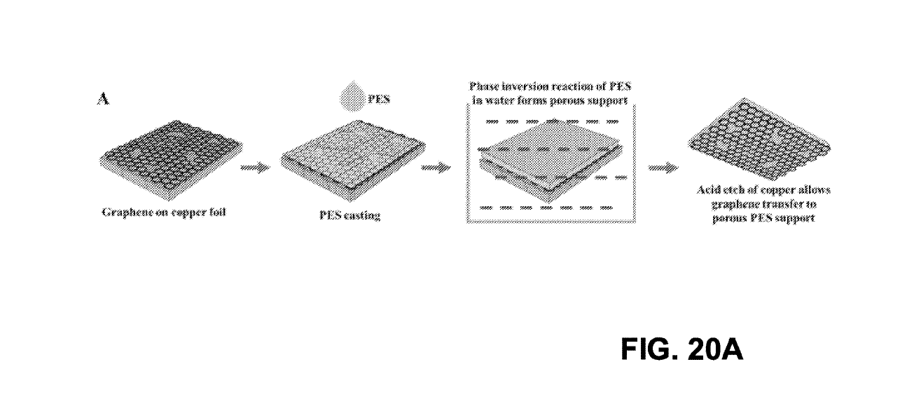

FIG. 18 illustrates experimental data of molecular concentrations in a process of separating a salt from a larger molecule using a commercial polymeric membrane. The data shown in FIG. 18 illustrates the use of a commercial 3.5 kiloDalton-5 kiloDalton membrane to separate L-Tryptophan from KCl.

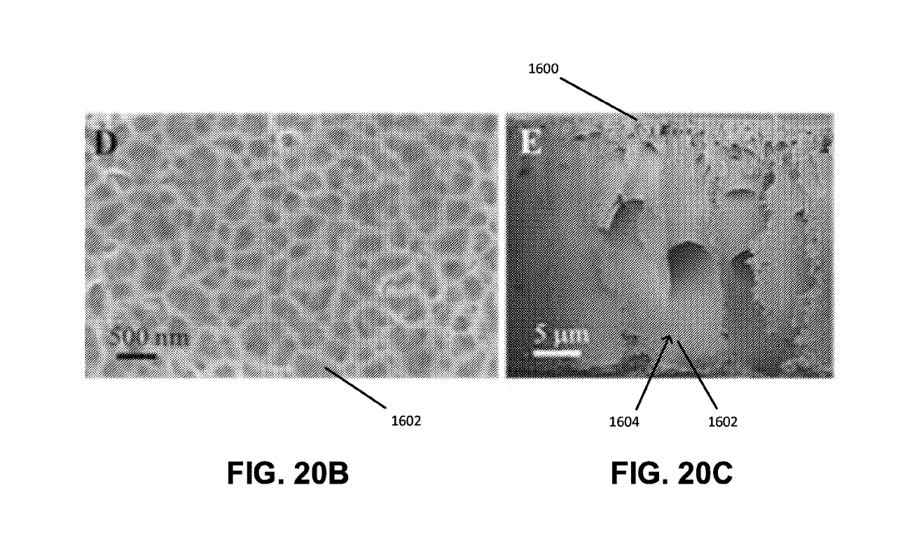

FIGS. 19A-19C depict experimental data of molecular concentrations in a process of separating a salt from a larger molecule using a nanoporous atomically thin membrane, according to some embodiments. The data shown in FIGS. 19A-C demonstrate the use of a composite membrane including a nanoporous atomically thin layer (NATM) of graphene to perform de-salting, that is, the separation of a salt from larger molecules.

In particular, FIG. 19A illustrates separation of L-Tryptophan from KCl with a NATM-based composite membrane with a support substrate having only a 10% porosity. FIG. 19B illustrates separation of a salt from a model small molecule vitamin B12, and FIG. 19C illustrates separation of a salt from a model small molecule Lysozyme. As can be seen, the results of FIG. 19A are comparable to those of the commercial membrane depicted in FIG. 18, yet the use of only 10% porosity of the support substrate suggests that, with a more porous substrate, faster diffusion than shown in this example should be expected. For example, up to ten times the diffusion shown in FIG. 19A could be expected using a more porous support substrate.

Each of the examples of FIGS. 19A-19C use PCTE membrane with graphene disposed thereon and interfacial polymerization applied to seal defects in the graphene. Again oxygen plasma etching cycles were applied to the atomically thin layers to form pores therein as described previously above. Conductivity and UV-Vis spectra were measured on the feed side of the membrane. The dotted lines denote an exponential fit to the concentration traces as measured using conductivity and UV-Vis spectra.

The trace of concentration as function of time measured on a feed side for a mixture of KCl and L-Tryptophan (FIG. 19A) for an active layer formed using a total of 30 s of plasma etching; a mixture of KCl and vitamin B-12 (FIG. 19B) for an active layer formed using a total of 60 s of plasma etching; and a mixture of KCl and Lysozyme (FIG. 19C). The permeate side was constantly flushed with DI water. As can be seen from the figures, the concentration of KCl initially drops rapidly in each case and then settles to follow an exponential fit. With increasing time, the concentration drop can be fitted with an exponential fit as shown by the dotted black line for each concentration trace with time. In both cases clear KCl transport across the membrane is seen starting from an initial concentration of 0.25 M for a 7 ml feed solution to a final concentration of about 0.05M (about 80% reduction). The transport of L-Tr (FIG. 19A) is significantly lower with a starting concentration of about 60 μM to a final concentration value of 40 μM (about 30% reduction). The transport of vitamin B12 (FIG. 19B) is however even lower with a starting concentration of about 72 μM to a final concentration value of about 62 μM (about 14% reduction). The transport of Lysozyme (FIG. 19C) is yet lower, with a starting and ending concentration that is about 75 μM. Lysozyme has size of approximately 3.8 nm. These observations indicate that the majority of the pores created by the described oxygen plasma pulsing process were in the 0-1 nm size range.

Many practical applications of de-salting involve molecules much larger than 1 nm, such as proteins, DNA, polysaccharides, drug binding studies, and/or excess reactants and are hence expected to be retained in factions larger than that measured for vitamin B12 (i.e. >86% retention in the example of FIG. 19B), and may be more in line with those results seen of Lysozyme in FIG. 19C. Based on these observations, it is believed that that facile oxygen plasma pulsing applied to an atomically thin layer, such as graphene, disposed on an underlying substrate and sealed using interfacial polymerization may be used to form nanoscale pores in an atomically thin layer of a composite membrane for use in applications such as de-salting, dialysis/or and ultrafiltration applications.

While any appropriate substrate may be used to support an atomically thin active layer as detailed above, in some embodiments, it may be desirable to minimize the number of transfer steps that an atomically thin active layer undergoes during formation and processing. Without wishing to be bound by theory, this may both reduce a number of processing steps which are involved, which may reduce processing costs, and reduce the chances for introducing damage to the atomically thin active layer during these transfer processes. Accordingly, the Inventors have recognized the benefits associated with forming a porous substrate to support an atomically thin active layer on the porous substrate to eliminate the step of transferring the atomically thin active layer onto a separately formed porous substrate while also offering easily scalable processing that may be applied to large area active layers. In some embodiments, the porous substrate may be a polyether sulfone (PES) support membrane. Though embodiments in which a porous substrate an active layer is disposed on may be made out of other materials including, but are not limited to, polyvinylidene difluoride (PVDF), polystyrene (PS), and other appropriate materials are also contemplated as the disclosure is not so limited.

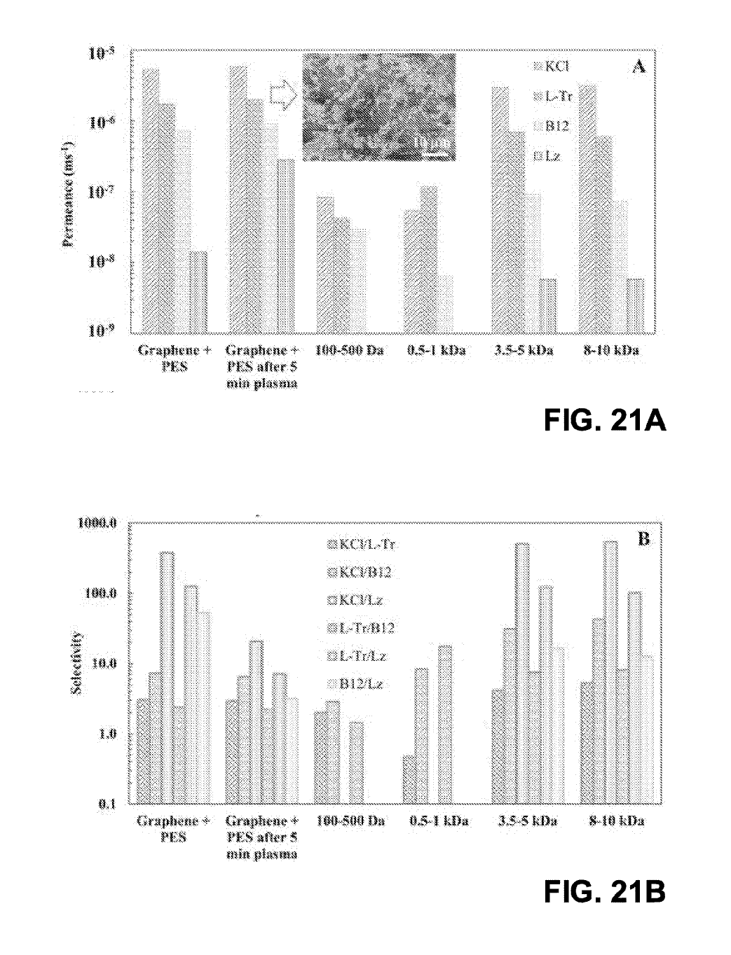

One embodiment of a method that may be used to form a porous substrate on an atomically thin active layer is illustrated in FIG. 20A. In the depicted embodiment, an atomically thin active layer, such as graphene, is grown on a substrate, such as copper, as described herein. Depending on the embodiment, the growth of the graphene may either be controlled to provide a desired distribution of pore sizes and/or the pores may be formed in the atomically thin active layer either prior to, or after the formation of the substrate. In either case, a layer of a polymer casting solution, which may correspond to a mixture of a desired polymer resin and one or more solvents, is deposited onto a surface of the atomically thin active layer using any appropriate method. Appropriate methods include, but are not limited to spin coating, dip coating, drop casting, or any other appropriate way of applying the material to the atomically thin active layer. After depositing the layer of polymer casting solution, phase inversion may be used to transform the deposited layer into a desired porous support substrate. Appropriate types of phase inversion may include, but are not limited to: precipitation due to solvent evaporation; precipitation due to controlled evaporation of a solvent as compared to a non-solvent in the casting solution; thermal precipitation where the deposited layer is cooled from a higher first temperature to a second lower temperature to induce phase separation; and/or immersion precipitation where the layer is immersed in a coagulation bath, such as deionized water, that causes the polymer casting solution to phase separate to form the desired porous structure. An example of phase inversion using a coagulation bath is illustrated in the figure, where the assembly is immersed in a coagulation bath including water to form a porous substrate. The assembly is then etched to remove the original substrate, i.e. a copper substrate, the atomically thin active layer is grown on.

While any appropriate polymer casting solution may be used, in some embodiments, a polymer casting solution may include a combination of between about 0.1 weight percent (wt %) and 30 wt %, 10 wt % and 20 wt %, or 16 wt % polyether sulfone (PES) resin; between or equal to 70 wt % and 90 wt %, 75 wt % and 85 wt %, or 82 wt % N-Methyl-2-pyrrolidone (NMP); and between or equal to 0 wt % to 20 wt %, 0.5 wt % to 20 wt %, 0.5 wt % to 10 wt %, 1 wt % and 3 wt %, or 2 wt % isopropanol. The casting solution may be held at an elevated temperature for a first duration and allowed to degas at a lower temperature for a second duration. For example, the casting solution may be held between 50° C. and 100° C., including at 75° C., for approximately 24 hours prior to being cooled to room temperature and allowed to de-gas for about 12 hours. These materials may be deposited onto an active layer formed on any appropriately sized substrate including, for example, foils with thicknesses between 15 μm and 20 μm as elaborated on in the examples. However, embodiments in which different thickness substrates are used are also contemplated. The polymer casting may then be immersed in a coagulation bath including deionized water.

While compositions with certain weight percentages and types of solvents and polymer resin are described above, it should be understood that porous substrates may be formed using polymer casting solutions that use different solvents, polymer resins, and/or weight percent ranges than those noted above as the disclosure is not so limited. For example, appropriate types of polymer resins may include, but are not limited to one or more of PES, PS, PVDF, a water insoluble polymer, and other conventional polymeric membrane materials. Appropriate types of additives may include, but are not limited to one or more of alcohols or any other appropriate type of small molecule. Additionally, appropriate types of solvents may include, but are not limited to, one or more of water, organic solvents, alcohols, acetone, isopropanol, ethanol, toluene, xylene, hexane, benzene, NMP, solutions of different ionics salts and water, combinations of the above, or any other appropriate type of solvent. Further, appropriate coagulation baths may include, but are not limited to, one or more of water, alcohols, acetone, isopropanol, ethanol, toluene, xylene, hexane, benzene, NMP, solutions of different ionics salts and water, combinations of the above, or any other appropriate type of coagulation bath.

The specific pore sizes, distributions, and other structures formed during phase inversion of a layer may be influenced by any number of different parameters including, but not limited to: solvent composition and concentration; polymer composition; layer thickness; bath composition; and temperature to name a few. However, as shown in FIGS. 20B and 20C, in some embodiments, the processing parameters may be selected to form a porous substrate that may include a first plurality of laterally interconnected pores 1600 located adjacent to a surface of an atomically thin active layer that the porous substrate is disposed on. The graphene layer whose cross section cannot be seen is located at the top of the depicted SEM micrograph. This first plurality of pores may be fluidly coupled to a second plurality of elongated pores 1602 that extend away from the first plurality of pores to a surface of the overall membrane located opposite the atomically thin active layer. The first plurality of pores may have an average dimension, such as an average diameter, that is less than an average diameter or width of the second plurality of elongated pores. In some embodiments, as shown in the figure, the porous substrate may also include a plurality of nano and/or micro pores 1604 formed in the walls of, and that interconnect, the second plurality of elongated pores.

In one embodiment, the first plurality of pores may have an average dimension that is between or equal to about 200 nm and 500 and the plurality of elongated pores may have average diameters or widths that are on the size of micrometers including between or equal to about 2 μm and 10 μm or 2 μm and 5 μm. Of course while particular ranges of pore sizes are detailed above, different ranges of pore sizes both smaller and larger than those noted above are also contemplated as the disclosure is not so limited.

Experiments regarding the manufacture and use of nanoporous graphene and polyether sulfone (PES) membranes were conducted. The experimental manufacture and characterization of these membranes is detailed further below.

Graphene growth was performed in a hot-walled tube furnace on copper foil (purity 99.9%, thickness 18 μm) that was cleaned by sonicating it in 15% HNO₃ to remove oxides and other contaminants from the surface. The copper foil was subsequently washed with deionized water and dried in nitrogen before being annealed at 1050° C. for 60 min in 60 sccm H₂ at ˜1.14 Torr. After annealing the foil was cooled to growth temperature in 15 min and graphene growth was performed by adding CH₄ (3.5 sccm ˜2.7 Torr) to H₂ at 800-1050° C. for 30 min followed by 30 min of 7 sccm CH₄ (˜3.6 Torr) and 60 sccm H₂. The foil was rapidly cooled in the growth atmosphere at the end of the growth.

Casting polymer solution was prepared by mixing 16 wt % polyether sulfone (PES) resin 82 wt % N-Methyl-2-pyrrolidone and 2 wt % isopropanol (IPA), and baked in an oven at 75° C. for ˜24 hours and subsequently allowed to cool and de-gas for about 12 hours. The casting was performed after adhering the copper foil including a graphene layer with an area greater than 5 cm⁻² (pre-etched in ammonium persulfate (APS) for 5 min to remove the graphene on the back side) onto an aluminum plate with Scotch tape (magic tape 810 about 19 mm width and about 50 μm in thickness). A disposable culture tube (diameter 13 mm, height 100 mm) with 3 windings of Scotch tape was used to spread the PES solution on graphene on copper in one, swift unidirectional stroke. The PES, graphene, and copper foil stack was then immersed in a de-ionized water bath for 30 min and permitted to undergo phase inversion after which the stack was released from the aluminum plate and the Cu foil was etched in APS to leave graphene suspended on a hierarchically porous PES support. The resulting stack of graphene and porous PES substrate was rinsed with deionized water followed by ethanol and then dried at room temperature.

FIGS. 20B and 20C are scanning electron micrographs of the formed stack of graphene and PES. FIG. 20B specifically shows a graphene layer disposed on top of the PES porous substrate with the PES porous substrate visible through the graphene. FIG. 20C presents a cross section of the stack of graphene and PES with graphene located at the top of the image, though the graphene cross section is not visible at this magnification. As shown in the figure, the PES substrate exhibits a hierarchical pore structure with pores having diameters of about 200-500 nm located in a layer adjacent to the graphene which are connected to much larger elongated pores that have widths on the order of several micrometers extending to the side of the PES substrate opposite the graphene layer. As also shown in the figure, the pore structure also includes micro and nano pores that connect laterally throughout the PES substrate. Such a pore structure may facilitate the divergent demands of low resistance to diffusion-driven transport while simultaneously supporting nanoporous graphene effectively using a simple membrane manufacturing process.

The permeance and selectivity of the above described membranes including a PES substrate were evaluated using diffusion driven flow for solutes such as KCl, L-Tryptophan, Vitamin B12 and Lysozyme (Lz). The performance of the above detailed membranes was compared with commercially available state-of-the-art conventional polymeric dialysis membranes (0.1-0.5 kDa, 0.5-1 kDa, 3.5-5 kDa, 8-10 kDa). During testing, the membranes were sandwiched between two side-by-side diffusion cells (Permegear Inc., 5 mm orifice, 7 mL volume) for diffusion driven flow measurements. All measurements were performed in triplicate.

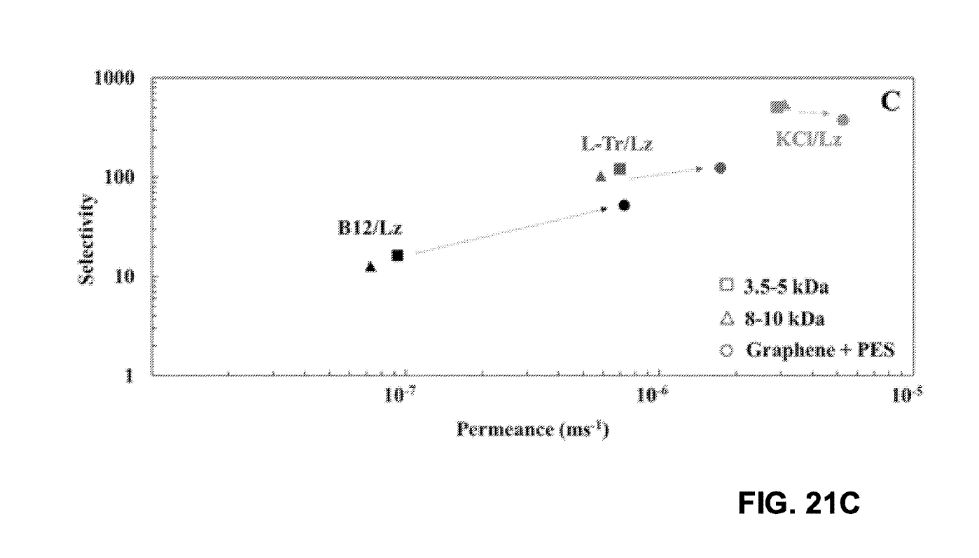

As shown in FIGS. 21A-21C, the graphene and PES stacks show distinctly higher permeance on the order of a 2 to 100 times increase compared to the conventional membranes along with better, or at the very least comparable selectivity. It should be noted that, the upper bound of a 100 times permeance increase was computed by comparing KCl permeance for the graphene and PES stack of about 5.27×10−6 ms⁻¹ to the permeance of a 0.5-1 kDa commercial membrane of about 5.40×10−8 ms⁻¹ as well as comparing Vitamin B12 permeance for the graphene and PES stack of about 7.25×10⁻⁷ ms⁻¹ to the permeance of a 0.5-1 kDa commercial membrane of about 6.47×10−9 ms⁻¹ respectively.

To confirm that the observed performance was due to the presence of the nanoporous graphene active layer, a graphene and PES membrane stack was subjected to 5 min of air plasma to effectively destroys the graphene, see SEM inset in FIG. 21A illustrating the damage to the graphene layer. The permeance and selectivity measurements for the graphene and PES stack after air plasma damage resulted in the stack exhibiting an increase of more than 1.5 orders of magnitude in Lysozyme permeance. This increase in Lysozyme permeance confirms that it was the nanoporous graphene, not the PES supporting substrate, that provided the observed size-selective transport of the synthesized membranes. Interestingly, the permeance of the salt and small molecules did not change significantly after the stack was exposed to the 5 min of plasma treatment. Without wishing to be bound by theory, this may indicate that the nanoporous graphene is essentially transparent for all species except lysozyme, and that the permeance is governed by the porous PES substrate. Therefore, further improvements are expected with thinner supporting substrate layers.

Referring again to FIG. 21C, the figure depicts selectivity vs permence for KCl vs Lysozyme, L-Tryptophan vs Lysozyme, and Vitamin B12 vs Lysozyme for the graphene and PES stack (circles) as well as commercial dialysis membranes for 3.5-5 kDa (square) and 8-10 kDa (triangles). As illustrated in the plot, the graphene and PES stack offers significant improvements over the conventional polymeric membranes with higher permeance and roughly equivalent or better selectivity for the tested salts and compounds.

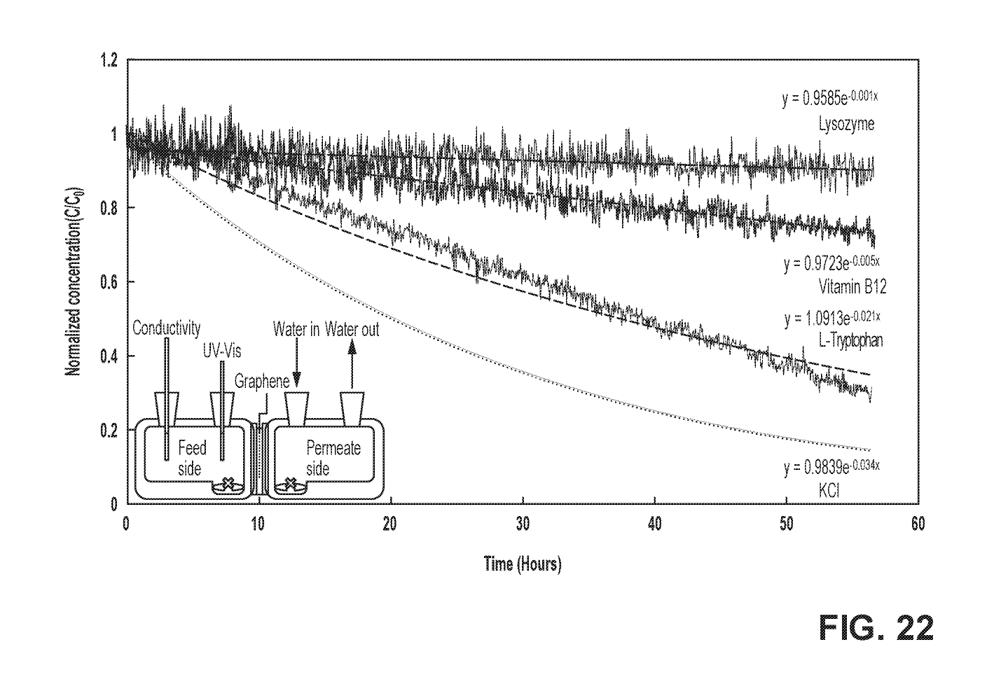

FIG. 22 is a graph depicting the de-salting of a small protein (Lysozyme) and size-selective separation of small molecules (dialysis) using the synthesized graphene and PES stacks. For these separation experiments 7 ml solutions with about 6-7.5×10⁻⁵M solute concentration (L-Tryptophan, Vitamin B-12, or Lysozyme) and 0.25 M KCl was placed on the feed side of a diffusion cell. It should be noted that only one solute mixed with KCl was measured at a time during these experiments. The solute concentration in the solution was monitored while the permeate side of the diffusion cell was constantly flushed with de-ionized water that was re-circulated from a reservoir with a volume of about 70 L using a peristaltic pump. In all cases a decrease in concentration for both KCl and the solute was observed to follow an exponential curve. The rate of change of the normalized concentrations was consistent with the size differences in the tested materials. Specifically, KCl (with a size of about 0.66 nm) exhibited a larger rate of change than L-Tryptophan (with a size of about 0.7-0.9 nm) which exhibited a larger rate of change than vitamin B12 (with a size of about 1-1.5 nm) which exhibited a larger rate of change than Lysozyme (with a size of about 3.8-4 nm). The observed behavior confirms size-selective transport across the graphene and PES stack consistent with the other experiments described above.

The above experiments confirm that the evaluated nanoporous graphene and PES stacks were effective at de-salting of even small proteins such as Lysozyme and dialysis based small molecule separation (L-Tryptophan, Vitamin B12) from a small protein. This indicates that the majority of the pores in the graphene were in the 0-4 nm size range. Additionally, while some leakage of Lysozyme was observed, this may be attributed to damage during membrane fabrication. In either case, the graphene and PES stacks exhibited a more than 2 times increase in measured permeance compared to previously demonstrated large area graphene membranes.

Having thus described several non-limiting embodiments, it should be appreciated that various alterations, modifications, and improvements of the embodiments disclosed herein will readily occur to those skilled in the art. Such alterations, modifications, and improvements are intended to be part of this disclosure, and are intended to be within the spirit and scope of the current disclosure as well. Further, though advantages of the present disclosure are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Various aspects of the present disclosure may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the disclosure may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A semi-permeable membrane for performing separation processes, the membrane comprising:
a porous substrate; and
an active layer disposed upon the substrate, wherein the active layer includes at least one atomically thin layer, the active layer having a plurality of open pores that allow transport of some species through the membrane while restricting transport of other species through the membrane, wherein the open pores have a mean pore size between 0.5 nm and 10 nm, and wherein the open pores have a number density between 10⁹ cm⁻² and 10¹⁴ cm⁻².

2. The membrane of claim 1, wherein the active layer comprises at least one of graphene, hexagonal boron nitride, molybdenum sulfide, vanadium pentoxide, silicon, doped-graphene, graphene oxide, hydrogenated graphene, fluorinated graphene, a covalent organic framework, a layered transition metal dichalcogenide, a layered Group-IV and Group-III metal chalcogenide, silicene, germanene, or a layered binary compound of a Group IV element and a Group III-V element.

3. The membrane of claim 1, wherein the active layer is substantially formed from graphene.

4. The membrane of claim 1, wherein the active layer has a plurality of defects, and the membrane further comprises a deposited material associated with the plurality of defects that reduces transport through the plurality of defects.

5. The membrane of claim 4, wherein the deposited material comprises at least one of polyamide, polyaniline, polypyrrole, calcium carbonate, or poly(lactic acid).

6. The membrane of claim 1, wherein the porous substrate comprises polydimethylsiloxane (PDMS).

7. The membrane of claim 6, wherein the porous substrate comprises a PDMS mesh.

8. The membrane of claim 1, wherein the porous substrate comprises a polycarbonate track etched membrane (PCTEM).

9. The article of claim 1, further comprising a polyether sulfone (PES) supporting substrate.

10. The membrane of claim 1, wherein the active layer comprises a plurality of atomically thin layers.

11. The membrane of claim 1, wherein the open pores have a mean pore size between 0.65 nm and 2 nm.

12. The membrane of claim 1, wherein the open pores have a number density between 10¹² cm⁻² and 5×10¹³ cm⁻².

13. A dialysis apparatus comprising the membrane of claim 1.

14. A method of performing dialysis, the method comprising:
separating a first group of species from a second group of species using a semi-permeable membrane, the semi-permeable membrane comprising:
a porous substrate; and
an active layer disposed upon the substrate, wherein the active layer includes at least one atomically thin layer, the active layer having a plurality of open pores that allow transport of species of the first group through the membrane while restricting transport species of the second group through the membrane, wherein the open pores have a mean pore size between 0.5 nm and 10 nm, and wherein the open pores have a number density between 10⁹ cm⁻² and 10¹⁴ cm⁻²
wherein the first group of species pass through the semi-permeable membrane primarily through diffusion.

15. The method of claim 14, wherein the first group of species include at least one salt or salt ion.

16. The method of claim 14, wherein the second group of species include at least one protein.

17. The method of claim 14, further comprising sealing a defect in the at least one atomically thin layer.

18. A method of forming a semi-permeable membrane, the method comprising:
disposing an atomically thin layer of a first material onto a surface of a porous substrate;
forming a plurality of open pores in the layer of the first material, the open pores allowing transport of some species through the membrane whilst restricting transport of other species through the membrane, wherein the open pores have a mean pore size between 0.5 nm and 10 nm, and wherein the open pores have a number density between 10⁹ cm⁻² and 10¹⁴ cm⁻².

19. The method of claim 18, further comprising depositing a second material into a plurality of defects of the layer of the first material.

20. The method of claim 19, wherein forming the plurality of open pores in the layer of the first material occurs after depositing the second material.

21. The method of claim 18, wherein the plurality of open pores are formed by etching the first material with an oxygen plasma.

22. The method of claim 21, wherein the first material is etched with the oxygen plasma for a total duration between 15 seconds and 90 seconds.

23. The method of claim 22, wherein etching the first material with the oxygen plasma further comprises pulsing the oxygen plasma.

24. The method of claim 23, wherein the pulses have durations between or equal to 5 seconds and 30 seconds.

25. The method of claim 23, wherein the oxygen plasma pulses are applied using a power between or equal to 0.1 W cm⁻² and 10 W cm⁻².

26. The method of claim 18, wherein the layer of the first material is an atomically thin layer of graphene.

27. The method of claim 18, wherein the porous substrate comprises polydimethylsiloxane (PDMS).

28. The method of claim 18, wherein the porous substrate comprises a polycarbonate track etched membrane (PCTEM).

29. The method of claim 18, wherein the open pores have a mean pore size between 0.65 nm and 2 nm.

30. The method of claim 18, wherein the open pores have a number density between 10¹² cm⁻² and 5×10¹³ cm⁻².

31. The method of claim 18, wherein the first material comprises at least one of graphene, hexagonal boron nitride, molybdenum sulfide, vanadium pentoxide, silicon, doped-graphene, graphene oxide, hydrogenated graphene, fluorinated graphene, a covalent organic framework, a layered transition metal dichalcogenide, a layered Group-IV and Group-III metal chalcogenide, silicene, germanene, or a layered binary compound of a Group IV element and a Group III-V element.

32. The method of claim 18, further comprising sealing a defect in the atomically thin layer.

33. The method of claim 18, further comprising forming a porous substrate on the atomically thin layer.
